(19) United States
(12) Patent Application Publication
(10) Pub. No.: US 2025/0193624 A1
(43) Pub. Date: Jun. 12, 2025

(54) SYSTEM FOR DETERMINING CUSTOMIZED AUDIO

(71) Applicant: Google LLC, Mountain View, CA (US)

(72) Inventors: Sinan Hersek, Seattle, WA (US); Dongeek Shin, San Jose, CA (US); Pouya Samangouei, San Francisco, CA (US); Rajeev Nongpiur, Mountain View, CA (US)

(21) Appl. No.: 18/974,669

(22) Filed: Dec. 9, 2024

Related U.S. Application Data
(63) Continuation-in-part of application No. 18/841,545, filed on Jan. 1, 0001.
(60) Provisional application No. 63/607,971, filed on Dec. 8, 2023.

(51) Int. Cl. H04S 7/00

(52) U.S. Cl. CPC H04S 7/303

(57) ABSTRACT

Disclosed implementations for generating personalized audio. In response to receiving sensor data corresponding with a physical characteristic of a user, a first function is determined based on a similarity between the physical characteristic of the user and a first model and a second function is determined based on a similarity of the physical characteristic between the user and a second model. A modified function, representing an audio response, is generated by combining the first function and the second function. An audio stream is generated based on the modified function.

### CROSS-REFERENCE TO RELATED APPLICATIONS

This application is a continuation-in-part of, and claims priority to, U.S. patent application Ser. No. 18/841,545, filed on Aug. 26, 2024, entitled “SYSTEM FOR DETERMINING CUSTOMIZED AUDIO”, which is a 35 U.S.C. § 371 National Phase Entry application from PCT/US2024/033007, filed on Jun. 7, 2024, entitled “SYSTEM FOR DETERMINING CUSTOMIZED AUDIO”, the disclosures of which are incorporated by reference herein in their entirety.

This application also claims priority to U.S. Provisional Patent Application No. 63/607,971, filed on Dec. 8, 2023, the disclosure of which is incorporated by reference herein in its entirety.

### BACKGROUND

Sound reproduction is the process of recording, processing, storing, and recreating sound, such as speech, music, and the like. When recording a sound, one or more audio sensors are used to capture sound in single or multiple positions for a recording device.

### SUMMARY

An audio signal can be customized for a listener using a personalized audio profile (or function). The personalized audio profile can be a type of audio listening profile configured specifically for the listener. Current approaches for generating a personalized audio profile for a listener include making measurements for the listener in an anechoic chamber using audio equipment. At least one technical problem with this approach is that such an approach is expensive and not feasible with typical user computing devices.

The implementations described herein provide at least one technical solution to these technical problems by generating a personalized audio profile for a listener from data collected by the listener using a personal computing device (e.g., a mobile device). In some example implementations, a listener can, via a computing device, broadcast sound and record both the sound and the position of the listener. In such example implementations, the listener is provided with instructions to record, in particular, his or her head while the sound is broadcast and recorded. The personalized audio profile is determined based on the recorded visual data and audio data. In other examples implementation, a user can, via a computing device, record visual and position data of his or her head and ears (in particular the pinna (or pinnae plural), which are the external part of the ear). In such example implementations, the user is provided with instructions for how to move the device when recording. The personalized audio profile is determined based on the recorded visual data.

The personalized audio profiles determined in the example implementation above can be employed to render audio tailored specifically to the unique physical characteristics of the listener and thereby making the experience more immersive. The personalized audio profile may be referred to as a personalized response or as a personalized impulse response.

It is appreciated that methods and systems, in accordance with the present disclosure, can include any combination of the aspects and features described herein. That is, methods in accordance with the present disclosure are not limited to the combinations of aspects and features specifically described herein, but also may include any combination of the aspects and features provided.

Accordingly, in one example, a method includes receiving sensor data corresponding with a physical characteristic of a user; determining a first function based on a similarity between the physical characteristic of the user and a first model; determining a second function based on a similarity of the physical characteristic between the user and a second model; generating a modified function, representing an audio response, by combining the first function and the second function; and generating an audio stream based on the modified function.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 is an example environment where a device is employed to determine a personalized impulse response for a user, according to an implementation of the described system;

FIG. 2A is an example architecture that can be employed to execute implementations of the present disclosure;

FIG. 2B is an example architecture of a response module, according to an implementation of the described system;

FIG. 3A is a block diagram of an example architecture that can be employed to execute implementations of the present disclosure;

FIG. 3B is a block diagram of an example architecture of a combiner module, according to an implementation of the described system;

FIG. 4A is another example architecture that can be employed to execute implementations of the present disclosure;

FIG. 4B is an example architecture of a feature extraction module, according to an implementation of the described system;

FIG. 4C is an example architecture of a weight calculation module, according to an implementation of the described system;

FIG. 4D is an example architecture of a summation module, according to an implementation of the described system;

FIG. 4E is an example architecture of a decoder module, according to an implementation of the described system;

FIG. 5A is yet another example architecture that can be employed to execute implementations of the present disclosure;

FIG. 5B is a present diagram of an example architecture of a decoder module, according to an implementation of the described system;

FIG. 6 is an example environment that can be employed to execute implementations of the present disclosure;

FIG. 7A is a flowchart of another non-limiting process that can be performed by implementations of the present disclosure;

FIG. 7B is a flowchart of another non-limiting process that can be performed by implementations of the present disclosure;

FIG. 7C is a flowchart of yet another non-limiting process that can be performed by implementations of the present disclosure; and

FIG. 8 is an example system that includes a computer or computing device that can be programmed or otherwise configured to implement systems or methods of the present disclosure.

### DETAILED DESCRIPTION

Humans locate sounds in three dimensions, even though we have only two ears, because the brain, inner ear, and the external ears (pinna) work together to make inferences about location. Generally, humans can estimate the location of a source of a sound based on cues derived from one ear (monaural cues) that are compared to cues received at both ears (difference cues or binaural cues). Among these difference cues are time differences of arrival of sounds and intensity differences of sounds. For example, sound travels outward from a sound source in all directions via sound waves that reverberate (or reflect) off of objects near the sound source. These sound waves bounce off an object and/or portions of the listener's body and can be altered in response to the impact. When the sound waves reach a listener (either directly from the source and/or after reverberating off an object[s]) they are converted by a listener's body and interpreted by the listener's brain. Accordingly, sounds are interpreted and processed by a listener in a personalized way based on the unique physical characteristics of the listener.

Sounds reproduced using audio equipment can be personalized or customized for a listener in a personalized audio profile, which can be used to improve the listening experience of the listener based on one or more of their physical characteristics. At least one technical problem with current approaches for generating such a personalized audio profile for a listener is that the current approaches often involve the use of complicated techniques and expensive equipment for making measurements for the listener.

At least one of the technical solutions to the technical problem described above includes generating personalized audio for a listener from data collected by the listener (and for the listener) using a typical personal computing device (e.g., a mobile device). The personalized audio can be used to render audio tailored specifically to the unique physical characteristics of the listener and thereby make the listening experience more immersive. The personalized audio profile can be generated (e.g., defined) using a variety of techniques including the use of impulse responses, transfer functions, and/or convolutions. Some aspects of impulse responses, transfer functions, and convolutions are described in more detail below by way of introduction.

A listener derives the monaural cues from the interaction between a sound source and the listener's anatomy where the original source sound is modified before entering the ear canal for processing by the auditory system. These modifications encode the source location and may be captured via an impulse response (also can be referred to as a response or as an audio response) that relates the source location and the ear location. More generally, the impulse response is the reaction of any dynamic system (e.g., the listener) in response to some external change (e.g., the audio signal). The impulse response can be configured to characterize the reaction of the dynamic system as a function of time (or possibly as a function of some other independent variable that parametrizes the dynamic behavior of the system). In some implementations, this impulse response is termed the head-related impulse response (HRIR) in the contest of a listener's response to an audio signal.

A transfer function is an integral transform, specifically a Fourier transform, of an impulse response. An integral transform can be an operation that converts or maps a function from its original function space (a set of functions between two fixed sets) into another function space. This transfer function can be referred to as the head-related transfer function (HRTF) and describes the spectral characteristics of sound measured at the tympanic membrane (the eardrum) when the source of the sound is in three-dimensional space. A transfer function, and specifically an HRTF, can be used to simulate externally presented sounds when the sounds are introduced through, for example, headphones. More generally, an HRTF is a function of frequency, azimuth, and elevation determined primarily by the acoustical properties of the external ear, the head, and the torso of an individual. As such, HRTFs can differ substantially across individuals. In this case, the function space of the impulse response is the time domain (how a frequency changes over time) while the function space of the transfer function is the frequency domain (how a signal is distributed within different frequency bands over a range of frequencies). However, both the impulse response (e.g., HRIR) and the transfer function (HRTF), in some implementations, can characterize the transmission between a sound source and the eardrums of a listener.

Said differently, how an ear receives a sound (e.g., sound waves) from a point in space (e.g., a sound source) can be characterized using a transfer function or an impulse response. Both the impulse response and transfer function describe the acoustic filtering or modifications to a sound, due to the presence of a listener (and/or any object), from a direction to the sound as the sound propagates in free field and arrives at the ear (more specifically the eardrum). In some in implementations, both the impulse response and transfer function describe the acoustic filtering or modifications to a sound, due to the presence of an object, from a direction to the sound as the sound propagates in free field and arrives at a portion of the object. As sound reaches the listener, the shape of the listener's body (especially the shape of the listener's head and pinnae) modifies the sound and affects how the listener perceives the sound. Specifically, an HRTF is defined as the ratio between the Fourier transform of the sound pressure at the entrance of the ear canal and the Fourier transform of the sound pressure in the middle of the head in the absence of the listener. HRTFs are therefore filters quantifying the effect of the shape of the head, body, and pinnae on the sound arriving at the entrance of the ear canal.

These modifications include, most notably, the shape of the listener's ear (especially the shape of the listener's outer ear); the shape, size, and mass, of the listener's head and body; the length and diameter of the ear canal; the dimensions of the oral and sinus cavities; as well as the acoustic characteristics of the space in which the sound is played can all manipulate the incoming sound waves by boosting some frequencies and attenuating others. All of these characteristics influence how (or whether) a listener can determine the direction of the sound's source (e.g., from where the sound is coming). These modifications create a unique perspective and perception for each listener as well as help the listener pinpoint the location of the sound source.

A convolution can include the process of multiplying the frequency spectra of two audio sources such as, for example, an input audio signal and an impulse response. The frequencies that are shared between the two sources are accentuated, while frequencies that are not shared are attenuated. Convolution causes an input audio signal to take on the sonic qualities of the impulse response, as characteristic frequencies from the impulse response common in the input signal are boosted. Put another way, convolution of an input sound source with the impulse response converts the sound to that which would have been heard by the listener if the sound had been played at the source location, with the listener's ear at the receiver location. In this way, impulse responses (e.g., an HRIR or an HRTFs) are used to produce virtual surround sound.

A convolution is more efficient (e.g., becomes a multiplication) in the frequency (Fourier) domain and therefore transfer functions are preferred when generating an audio signal for an individual via convolution. Accordingly, a pair of transfer functions (e.g., one HRTF for each ear) can be used to synthesize a binaural sound that is perceived as originating from a particular point in space. Moreover, some consumer home entertainment products designed to reproduce surround sound from stereo audio devices (e.g., two or more speakers) can use some form of a transfer function(s). Some forms of transfer function processing have also been included in computer software to simulate surround sound playback from loudspeakers.

As noted above, current approaches for generating a personalized transfer function (or personalized impulse responses) for a listener (and/or any object) include measurements collected in an anechoic chamber using audio equipment. At least one technical problem with this approach is that such an approach is expensive and not feasible with user computing devices. Said differently, such an approach does not scale to consumer devices. Another approach includes employing a neural network model or signal processing algorithm to determine an appropriate personalized transfer function based on images of the user's head and/or pinna. However, at least one technical problem with this approach is that the personalized transfer function determined by such an approach may not be very accurate (e.g., well fitting for the user) as the intricate sound diffraction across the ridges and undulation within the pinna are not captured. Moreover, measurements collected in an anechoic chamber take a considerable amount of time and the process is not user-friendly.

The implementations described herein provide at least one technical solution to these technical problems. In particular, implementations of the described system generate an impulse response (e.g., a personalized impulse response) for a user (and/or object) using a computing device (e.g., a mobile device) and in-ear microphones. A transfer function can then be generated based on the impulse response (e.g., using an inverse transfer function). Other implementations of the described system provides a measurement-based approach for generating a transfer function (e.g., a personalized transfer function) for a user (and/or object) using a computing device (e.g., a mobile device) and in-ear microphones. The transfer function can then be used to generate an audio signal. For example, an audio signal that is specifically tailored to a user (e.g., via headphones or loudspeakers).

In an example scenario, the computing device broadcasts sound (e.g., white noise broadcast via a loudspeaker) and provides instructions (e.g., via the display) for the user to move the device around his or her head. In such an example, the computing device may be configured to record, as the user moves the device, the broadcasted sound via the in-ear microphones and sensor data (e.g., video, inertial measurement unit (IMU) data) via sensors such as an imaging device (e.g., a camera) and/or (IMU) sensor. The sensor data may include, for example, position information of the user (e.g., in particular, the position of the user's head) as well as head and body movement of the user while the sound is broadcast. In some implementations, the computing device is configured to determine, based on the sensor data, the spatial coordinates of the device with respect to the user's head. The computing device may then determine the personalized impulse response for the user based on these spatial coordinates and the recorded audio.

In another example scenario, the computing device provides instructions (e.g., via a display) for the user to move the device around his or her head. In such an example, the computing device may be configured to record, as the user moves the device, sensor data (e.g., video, IMU data) via sensors such as an imaging device and/or an IMU sensor. The sensor data may include, for example, position information of the user (e.g., in particular, the position of the user's head and pinnae) as well as head and body movement of the user during recording. In some implementations, the computing device is configured to determine, based on the sensor data, the spatial coordinates of the device with respect to the user's head. The computing device may then determine the personalized transfer function for the user based on these spatial coordinates and the recorded sensor data.

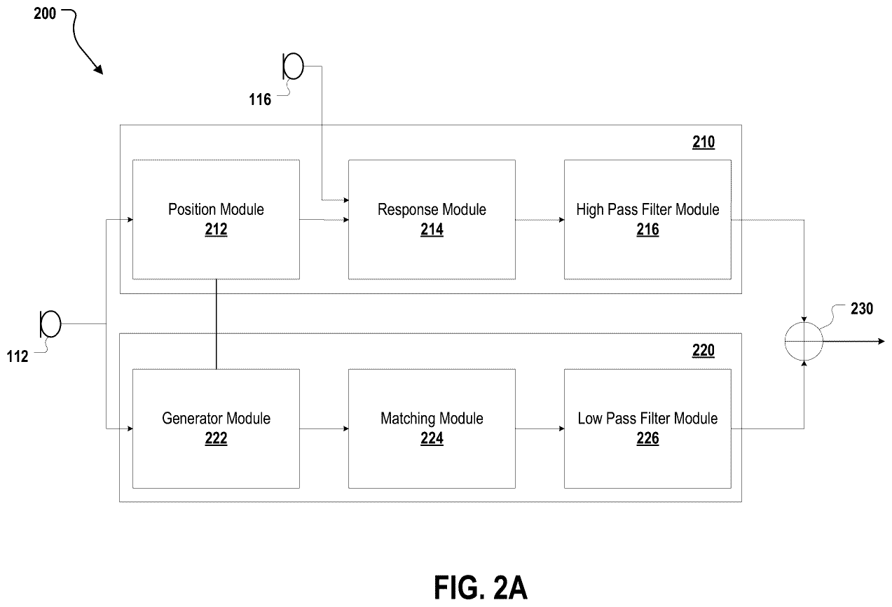

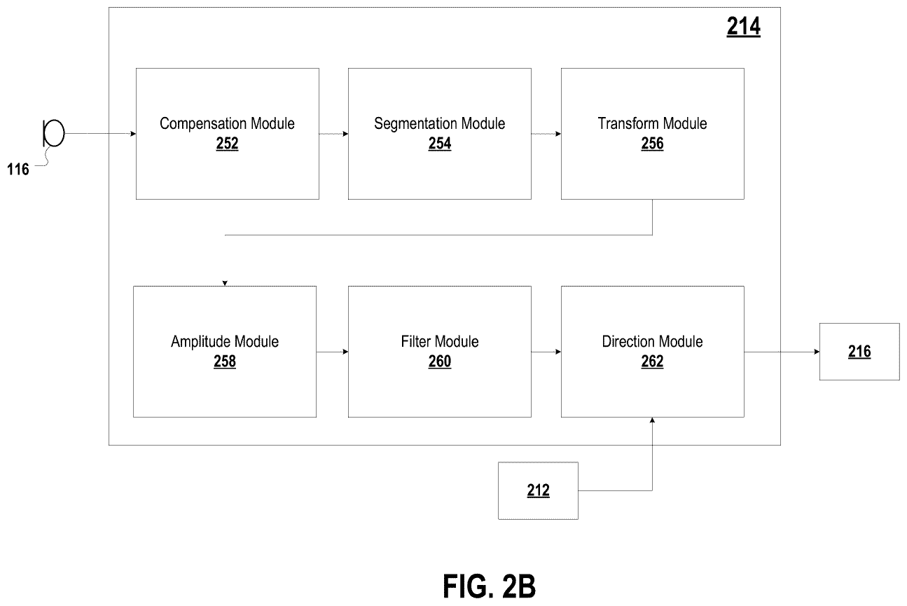

In some implementations, the described system determines a personalized impulse response based on an audio signal as well as sensor data captured while the sound is broadcast from an audio source (e.g., a speaker embedded in a mobile device). More specifically, a user may employ a device (e.g., a mobile device) to broadcast sound (e.g., white noise). While the sound is broadcast, the user may receive instructions for how to move the device around his or her head. The position of the user (e.g., the user's head and body position[s]) is captured via an imaging sensor (e.g., a camera and/or an IMU sensor) while simultaneously (or substantially simultaneously), a recording device (e.g., two microphone embedded in the user's ears) captures the audio signal. Position data (related to the position of the user during the broadcast) is determined based on the recorded sensor data (e.g., video, IMU data). In some cases, for example, this position data includes positional information of the user's head in relation to the audio source and recording device, which is synchronized with the audio signal. Multiple impulse responses are determined (see the descriptions of FIGS. 2A and 2B below for more detail) based on the recording and the position data. In some cases, a filter (e.g., a high-pass filter) is applied to the impulse responses personalized impulse response for the user.

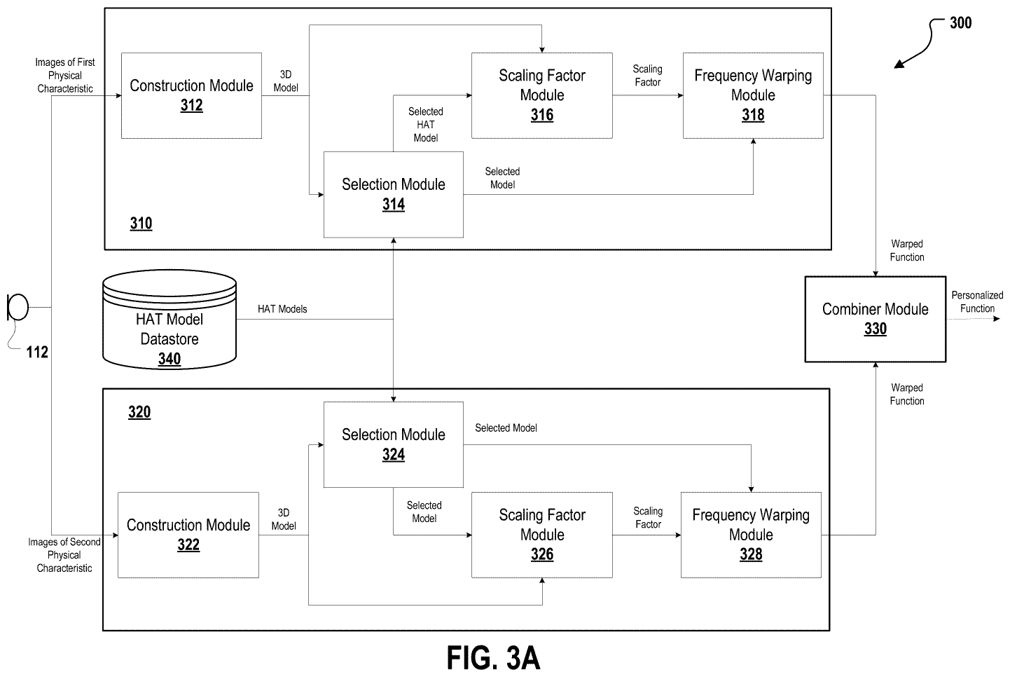

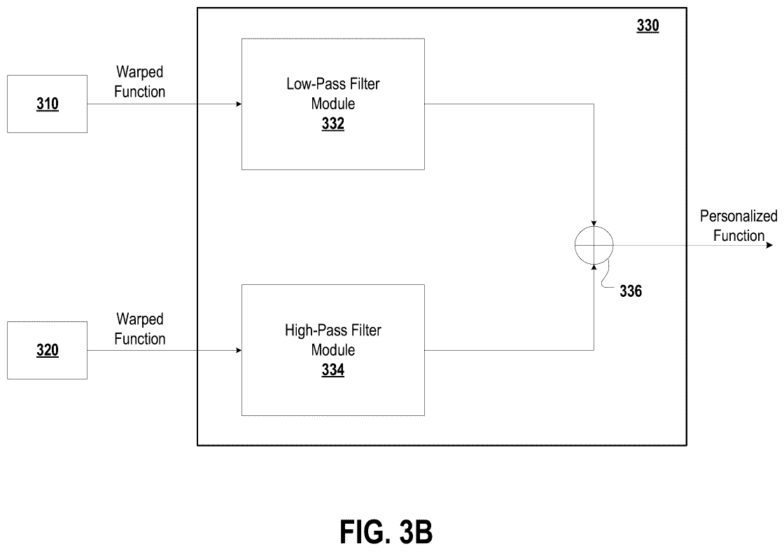

In some implementations, the described audio signal personalization system determines a personalized transfer function based on sensor data captured as the user moves the device around his or her head. More specifically, a user employs a device (e.g., a mobile device) to capture sensor data (e.g., image data). The user may receive instructions for how to move the device around his or her head. The position of the user (e.g., the user's head and body position[s]) is captured via an imaging sensor (e.g., a camera and/or an IMU sensor). Position data (related to the position of the user) is determined based on the recorded sensor data (e.g., video, IMU data). In some cases, for example, this position data includes positional information of the user's head in relation to the device. A three-dimensional (3D) representation of the user's head and a 3D representation of the user's pinnae are generated with the video and IMU sensor signals. A head-and-torso (HAT) model and associated HRTF are selected based on each 3D representation. The HAT models are scaled to fit the respective 3D representation and the associated HRTFs are modified (warped) based on the respective scaling factors. In some cases, a filter (e.g., a high-pass filter and a low-pass filter) is applied to the modified HRTFs, which are combined to form the personalized transfer function for the user (see the descriptions of FIGS. 3A and 3B below for more detail).

At least one technical effect can be the ability to personalize the transfer function (or audio profile for a listener) which can provide the user with a more immersive and accurate spatial-audio experience. Having a more immersive and accurate spatial-audio experience can enable the in-ear audio devices to be used with smartphones, extended reality (XR) devices (e.g., augmented reality (AR) devices, virtual reality (VR) devices, or mixed reality (MR) devices), and other head mounted display devices. Personalizing the transfer function can, for example, be accomplished using the in-ear audio device and a mobile device. In other words, expensive systems (e.g., an anechoic chamber) may be obviated.

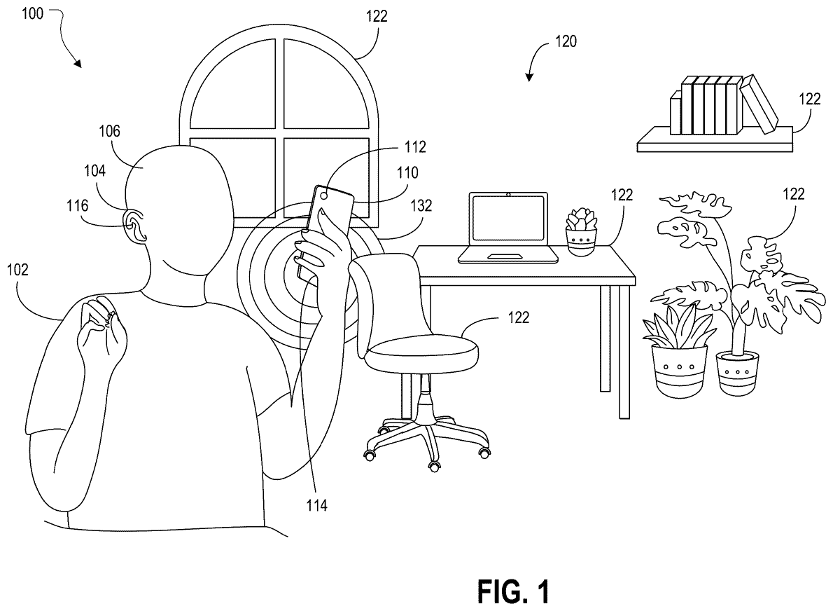

FIG. 1 illustrates a block diagram of an example environment 100 (e.g., a room) where a device 110 (e.g., a mobile device) is employed (e.g., by a user 102) to determine a personalized impulse response for the user 102 according to implementation of the described system. The device 110 can be configured to generate personalized audio for a listener from data collected by the listener (and for the listener) using the device 110. The personalized audio can be used to render audio tailored specifically to the unique physical characteristics of the user 102 and thereby make a listening experience more immersive for the user 102. The personalized audio profile can be generated (e.g., defined) using a variety of techniques including the use of impulse responses, transfer functions, and convolutions, which are described in more detail below.

The device 110 includes one or more sensors 112 and one or more electroacoustic transducers 114 and is coupled to one more audio sensors 116 that may be placed in one or both of the user's ears or pinnae 104. The sensors 112 are devices (e.g., a camera, IMU sensors, and the like) configured to detect and convey information in the form of images, IMU data, and the like. In some cases, IMU data includes motion data in a time-series format. This motion data may include acceleration measurements as well as angular velocity measurements, which can be represented in a three-axis coordinate system and together yield a six-dimension measurement time series stream.

The electroacoustic transducers 114 (e.g., a loudspeaker) are devices configured to convert an electrical signal into sound waves. The audio sensors 116 are devices that are configured to detect sounds and convert the detected sounds into an audio signal (e.g., an electrical audio signal). Example audio sensors include, but are not limited to, microphones, piezoelectric sensors, and capacitive sensors. FIG. 1 depicts the audio sensors 116 as coupled to the device 110 via a wired connection (e.g., wired earbuds); however, implementations of the present disclosure can be realized with audio sensors 116 coupled to the device 110 any number of ways including a wireless connection.

As depicted, the environment 100 includes features 122 and structural elements 120 (e.g., walls, floors, ceilings). FIG. 1 depicts the example environment 100 with one or more features 122 (e.g., a table books, a window, a chair, flowers, and/or the like); however, implementations of the present disclosure can be realized within an environment having any number of features as well as any configuration of the respective structural elements 120.

As depicted in FIG. 1, the user 102 moves (e.g., moves in response to an instruction in a user interface) the device 110 around his or her head. In some cases, the user moves the device as the electroacoustic transducers 114 broadcast the sound waves 132. The audio sensors 116 are configured to record the audio (e.g., generate an audio signal based on the received sound waves 132) and provide the recorded audio signal to the device 110. The audio sensors 116 may be configured to capture the sound waves 132 directly from the electroacoustic transducers 114 or indirectly after the sound waves 132 reflect off of one of the features 122 or structural elements 120. In some implementations, the audio sensors 116 are configured to capture/record samples from the sound waves 132 generated from the electroacoustic transducers 114. In some implementations, the audio sensors 116 are configured to generate a series of impulsive signals (e.g., the audio signal) based on the samples.

In some cases, for a complete recording, the user 102 moves the device 110 around his or her head to capture the audio data, video data, and/or IMU data from many possible angles and/or along one or more paths. In some cases, the user 102 receives prompts from a user interface of the device 110 that includes instructions for how and/or when to move the device 110. In some cases, the user 102 receives prompts as the audio broadcasts from the electroacoustic transducers 114. In some cases, the user interface is configured to display a map of regions of the user's head 106 and pinnae 104 that have been mapped and direct the user to the areas that have not been mapped.

In some implementations, the device 110 is configured to synchronize the audio and sensor data (e.g., video and/or IMU data). In some implementations, the device 110 is configured to process the audio data with both low-frequency processing and high-frequency processing. In some implementations, the generated low-frequency and high-frequency components are combined into a personalized impulse response for the user 102.

In some implementations, the device 110 is configured to process the sensor data (e.g., video and/or IMU data) to determine a first transfer function from a first model fit that is fit to the shape and size of the user's head 106 and second transfer function from a second model that is fit the shape and size of the user's pinnae. In some implementations, the first transfer function is processed with high-frequency processing and the second transfer function with low-frequency processing. In some implementations, the generated low-frequency and high-frequency components are combined into a personalized transfer function for the user 102.

In some implementations, for high-frequency component processing, position data is determined from the imaging data and/or the IMU data received from the sensors 112. The position data includes, for example, the direction and relative distance of the audio source (e.g., the electroacoustic transducers 114) with respect to the center of the user's 102 head (e.g., the mid-point between the ear openings). In some implementations, the device 110 is configured to determine the impulse responses across the various directions based on the position data and the recorded audio signal. In some implementations, computed impulse responses are passed through a high-pass filter to derive the high-frequency component of the personalized impulse response for the user 102.

In some implementations, for high-frequency component processing, a 3D representation of the user's head 106 is generated with the video and IMU sensor signals. The 3D head representation may be compared with corresponding head shapes in a dataset of HAT models for previously measured heads and the HAT models with best-matching model to the 3D head model is selected from the dataset. The transfer function associated with the selected HAT model scaled and frequency warped. Once scaled and warped to fit the 3D model of the user's head 106, the transfer function is passed through a high-pass filter to derive the high-frequency component of the personalized transfer function for the user 102.

In some implementations, for low-frequency component processing, a 3D representation of the user's head is reconstructed with the video and IMU sensor signals. The 3D head representation may be compared with corresponding head shapes in a dataset of previously constructed impulse responses and the impulse response with the best-matching head-shape is selected from the dataset. The selected impulse response is passed through a low-pass filter to derive the low-frequency component of the personalized impulse response for the user 102.

In some implementations, for low-frequency component processing, a 3D representation of the user's pinnae 104 is generated with the video and IMU sensor signals. The 3D pinnae representation may be compared with corresponding pinnae shapes in a dataset of HAT models for previously measured pinnae and the HAT models with best-matching model to the 3D pinnae model is selected from the dataset. The transfer function associated with the selected HAT model scaled and frequency warped. Once scaled and warped to fit the 3D model of the user's pinnae 104, the transfer function is passed through a low-pass filter to derive the low-frequency component of the personalized transfer function for the user 102.

In some implementations, the high-frequency component and the low-frequency are combined to form a personalized impulse response for the user 102. A personalized transfer function can then be obtained from the personalized impulse response by applying a transform. For discrete-time systems, the Z-transform (which converts a discrete-time signal into a complex valued frequency-domain representation) may be used. For continuous-time systems, the Laplace transform (an integral transform that converts a function of a real variable to a function of a complex variable) may be used. The Z-transform can be considered a discrete-time equivalent of the Laplace transform.

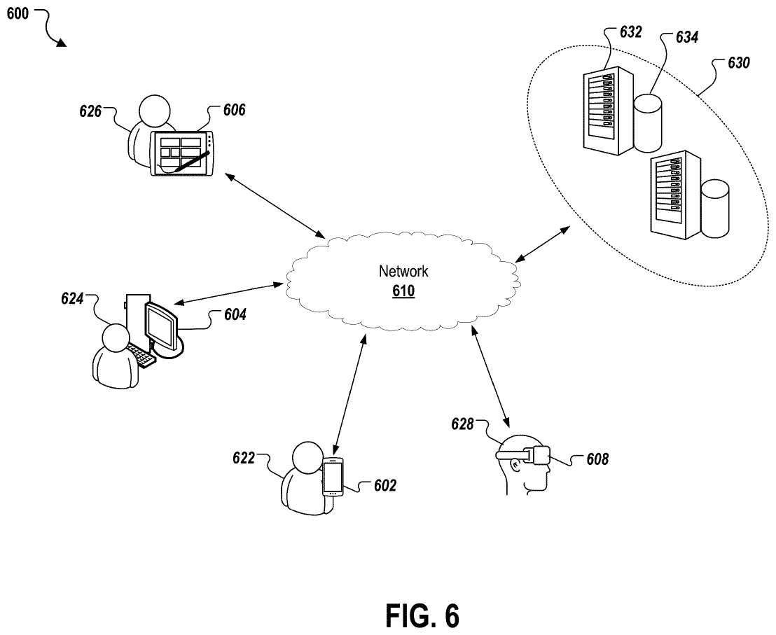

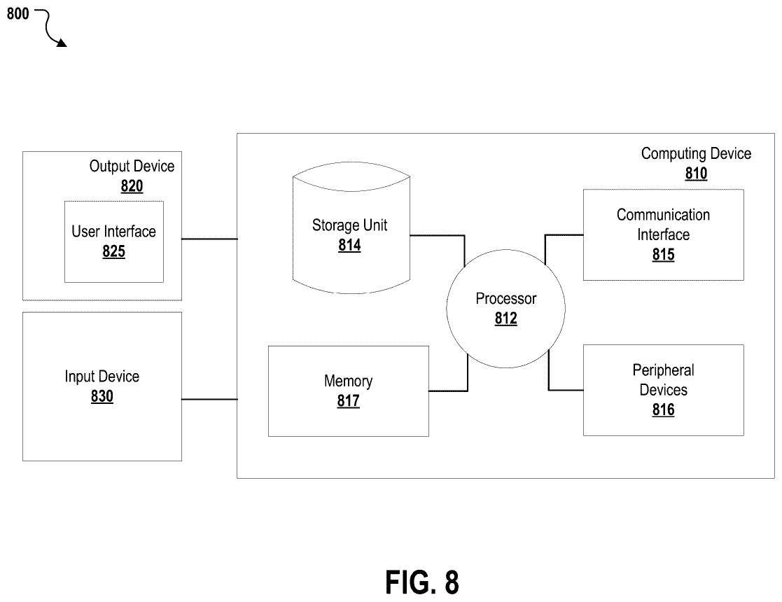

The device 110 is substantially similar to computing device 810 depicted below with reference to FIG. 8. Moreover, in the figures and descriptions included herein, device 110 is a mobile device such as a smartphone; however, it is contemplated that implementations of the present disclosure can be realized with any of the appropriate computing device(s), such as the computing devices 602, 604, 606, and 608 described below with reference to FIG. 6.

FIG. 2A is a block diagram of an example architecture 200 for the described audio signal personalization system. The example architecture 200 can be employed for the computation of a personalized impulse response. As depicted, the example architecture 200 includes a high-frequency processing module 210 and a low-frequency processing module 220. The high-frequency processing module 210 determines a high-frequency component of a personalized impulse response based on the image data and/or IMU data recorded by the sensors 112 as well as the audio data recorded by the audio sensors 116, and the low-frequency processing module 220 determines a low-frequency component of a personalized impulse response based on the image data and/or IMU data recorded by the sensors 112.

The combiner module 230 can be configured to combine the high-frequency component and low-frequency component into the resulting personalized impulse response for the user 102. In some cases, the resulting personalized impulse response is based on distances that are close to the head of the user 102 and have somewhat near-field characteristics. Accordingly, in such cases, various interpolation techniques (e.g., a function related to the scattering of sound off the user 102 or spherical harmonic decomposition) can be applied to derive a far-field version of the personalized impulse response.

As depicted in FIG. 2A, the high-frequency processing module 210 includes position module 212, response module 214, and high-pass filter module 216 and the low-frequency processing module 220 includes generator module 222, matching module 224, and low-pass filter module 226. In some implementations, the modules 210, 212, 214, 216, 220, 222, 224, and 230 are executed via an electronic processor of the device 110, depicted in FIG. 1. In some implementations, the modules 210, 212, 214, 216, 220, 222, 224, and 230 are provided via a back-end system (such as the back-end system 630 described below with reference to FIG. 6) and the device 110 is configured to communicate with the back-end system via a network (such as the communications network 610 described below with reference to FIG. 6).

In some implementations, the position module 212 (also can be referred to as a position computation module) maps a direction and relative distance of the electroacoustic transducers 114 (e.g., the source of the audio) with respect to a position of the head of the user 102 as position data over the recorded period of time (e.g., the time during with the user 102 moves the device 110 around his or her head as audio is broadcast via the electroacoustic transducers 114) based on image data and/or IMU data recorded by the sensors 112.

In some implementations, motion tracking can be employed to compute the relative orientation and position of the head of the user 102 based on received image data and/or IMU data. In some implementations, key-points for both left and right ears of the user 102 are extracted and estimated in the global frame of motion tracking. These key-points can be used to formulate ear coordinates, center of head, and calculate the relative pose of the sensors 112 with respect to the head of the user 102. In some examples, the position of the head of the user 102 is a center of the head of the user 102 determined based on a mid-point between the ear openings of the user 102. The generator module 222 described below may employ a similar technique to construct a 3D representation of the head of the user 102. The determined position data is provided to the response module 214 (which can also be referred to as an impulse response generator module) in a time-series format.

The response module 214 determines the impulse response across the various directions based on the position data and audio data recorded by the audio sensors 116 of the audio broadcast by the electroacoustic transducers 114. The description of FIG. 2A below includes a detailed description of how the impulse response is determined by the response module 214. The high-pass filter module 216 processes the impulse response through a high-pass filter to derive a high-frequency component of the personalized impulse response for the user 102. Generally, a high-pass filter is an electronic filter that passes signals with a frequency higher than a cutoff threshold frequency and attenuates signals with frequencies lower than the cutoff threshold frequency. The amount of attenuation for each frequency can be adjusted depending on the filter design as well as the output requirements (e.g., the type and configuration of the system employing a personalized transfer function determined from the personalized impulse response to render sound). In some cases, the high-pass filter is modeled as a linear time-invariant system.

In some implementations, the generator module 222 generates a 3D representation of the head of the user 102 based on image data and/or IMU data provided by the sensors 112. For example, the generator module 222 may be configured to generate the 3D representation of the head of the user 102 using a neural network. The matching module 224 compares the 3D head representation with corresponding head shapes in an impulse response dataset (e.g., a database of impulse response models collected from available datasets as well as previously measured/generated models) and selects a best-matching impulse response from the dataset based on selection criterion criteria (e.g., matching position points, matching size, matching shape, and the like). The low-pass filter module 226 processes the selected impulse response through a low-pass filter to derive a low-frequency component of the personalized impulse response for the user 102. Similar to the high-pass filter, a low-pass filter is an electronic filter that passes signals with a frequency lower than a cutoff threshold frequency and attenuates signals with frequencies higher than the cutoff threshold frequency.

Generally, low-frequency components include frequencies lower than the cutoff threshold frequency while high-frequency components include frequencies higher than the cutoff threshold frequency. In some implementations, the cutoff threshold frequency is determined or set based on the specific application of the generated personalized impulse response as well as the configuration of the device 110, the electroacoustic transducers 114, and the audio sensors 116. In some implementations, cutoff threshold frequency is set to a frequency (or range of frequencies) within the bounds of the frequency range for human hearing, from about 20 hertz (Hz) to about 20 kilohertz (kHz); however, the exact frequency response of the low-pass filter and the high-pass filter depend on the design of each filter.

As described above, the combiner module 230 is configured to combine the high-frequency component provided from the high-pass filter module 216 and the low-frequency component provided from the low-pass filter module 226 into the resulting personalized impulse response for the user 102. In some implementations, the low-frequency component models the shape of the head while the high-frequency component models the shape of the pinna. In some cases, because the pinna is more difficult to accurately model (and therefore actually select models from a database), the HRIR is generated (see the description of FIG. 2A) to model, for example, the pinna of the user 102.

FIG. 2B is a block diagram of an example architecture for the response module 214 described above with reference to FIG. 2A. As depicted, the example architecture includes compensation module 252, segmentation module 254, transform module 256, amplitude module 258, filter module 260, and direction module 262. In some implementations, the modules 252, 254, 256, 258, 260, and 262 are executed via an electronic processor of the device 110, depicted in at least FIG. 1. In some implementations, the modules 252, 254, 256, 258, 260, and 262 are provided via a back-end system (such as the back-end system 630 described below with reference to FIG. 6) and the device 110 is configured to communicate with the back-end system via a network (such as the communications network 610 described below with reference to FIG. 6).

The compensation module 252 processes the audio data (e.g., signal) recorded by the audio sensors 116 to compensate for the amplitude response of the electroacoustic transducers 114 and the audio sensors 116. For example, in some implementations, the compensation module 252 determines the amplitude response of the electroacoustic transducers 114 and the audio sensors 116 based on information provided in a respective datasheet or a calibration procedure where, for example, the user 102 plays sound (e.g., white noise) from the electroacoustic transducers 114 at close distance (e.g., within a few feet) to the audio sensors 116. The inverse amplitude response of the electroacoustic transducers 114 (e.g., equalizing the transducer to provide a flat response across the frequency spectrum) and the audio sensors 116 is then determined based on the amplitude response. In some cases, the compensation module 252 does not compensate for the lower-frequency portion.

The segmentation module 254 segments the compensation signal into overlapping frames of appropriate length and step-size and the transform module 256 computes the integral transform (e.g., a fast Fourier transform [FFT]) for each frame (i.e., generating FFT frames). In some cases, the transform module 256 computes a short-term Fourier transform (STFT) for analyzing signals whose frequency content changes over time. In some examples, for each of the FFT frames, the amplitude module 258 computes an amplitude-response and the filter module 260 derives the minimum-phase filter from each of the amplitude responses. A minimum phase filter (e.g., an analog filter) can be configured to yield variable phase shifting with frequency. In control theory and signal processing, a linear, time-invariant system is minimum-phase when the system and its inverse are causal and stable. The difference between a minimum-phase and a general transfer function is that a minimum-phase system has the poles and zeros of its transfer function in the left half of the s-plane representation (in discrete time, respectively, inside the unit circle of the z plane).

The direction module 262 processes the position data provided by the position module 212 (see FIG. 2A) to add position labels (e.g., related to the direction and distance of the source of the audio) to the derived minimum-phase filters to form the HRIR, which is provided to the high-pass filter module 216 (see FIG. 2A) to derive the high-frequency component of the personalized impulse response for the user 102.

FIG. 3A is a block diagram of an example of another architecture 300 for the described audio signal personalization system. The example architecture 300 can be employed for the computation of a personalized transfer function by performing a best fit of the shape of a user's physical characteristics (e.g., the user's head and pinnae shape) with a dataset of HAT models, which includes scanned geometry of a human head and torso, and respective measured or computed HRTFs. At least one technical advantage provided via the example architecture 300 is that a personalized HRTF can be determined with a small dataset (even a dataset with just a single HAT model) but becomes more accurate as the size of the dataset increases.

As depicted, the example architecture 300 includes head function module 310, pinnae function module 320, HAT model datastore 340, and combiner module 330. The head function module 310 selects and scales an HAT model from the HAT model datastore 340 with the closed shape to a 3D model of a user's head (e.g., user's 102 head 106 described above with reference to FIG. 1), which is generated from sensor data (e.g., images) collected from a device (e.g., the device 110 described above with reference to FIG. 1). In some implementations, a scaling factor to match the head-size of the HAT model to the user's head is computed.

Similarly, the pinnae function module 320 selects and scales an HAT model from the HAT model datastore 340 with the closed shape to a 3D model of the user's pinnae (e.g., a user's 102 pinnae 104 described above with reference to FIG. 1), which is generated from the sensor data collected from the device. In some implementations, a scaling factor to match the pinnae-size of the HAT model to the user's pinnae is computed. In some implementations, the corresponding HRTFs of the selected HAT models are modified based on the respective scaling factors.

The combiner module 330 combines the modified HRTFs to derive the personalized HRTFs for the user. For example, in some implementations the combiner module 330 processes the modified head HRTF through a low-pass filter and the modified pinnae HRTF through a high-pass filter to form the low-frequency component and high-frequency component of a personalized HRTF for the user. Audio can then be generated based on the personalized HRTF and provided to the user to create an immersive and accurate spatial-audio experience.

As depicted in FIG. 3A, the head function module 310 (also can be referred to as a function module or as a first function module) includes head construction module 312 (also can be referred to as a construction module or as a first construction module), head selection module 314 (also can be referred to as a selection module or as a first selection module), head scaling factor module 316 (also can be referred to as a scaling factor module or as a first scaling factor module), and head frequency warping module 318 (also can be referred to as a frequency warping module or as a first frequency warping module) and the pinnae function module 320 (also can be referred to as a function module or as a second function module) includes pinnae construction module 322 (also can be referred to as a construction module or as a second construction module), pinnae selection module 324 (also can be referred to as a selection module or as a second selection module), pinnae scaling factor module 326 (also can be referred to as a scaling factor module or as a second scaling factor module), and pinnae frequency warping module 328 (also can be referred to as a frequency warping module or as a second frequency warping module).

In some implementations, the modules 310, 312, 314, 316, 318, 320, 322, 324, 326, 328, and 330 (or at least one module thereof is) are executed via an electronic processor of a device, such as the device 110 described above with reference to FIG. 1 or computing device 810 described below with reference to FIG. 8. In some implementations, the modules 310, 312, 314, 316, 318, 320, 322, 324, 326, 328, and 330 (or at least one module thereof is) are provided via a back-end system, such as the back-end system 630 described below with reference to FIG. 6, and the device (e.g., device 110 or computing device 810) is configured to communicate with the back-end system via a network, such as the communications network 610 described below with reference to FIG. 6.

In some implementations, the head construction module 312 generates a 3D model of the user's head based on received sensor data. In some implementations, the head construction module 312 receives the sensor data collected from the one or more sensors 112 as described above with reference to FIG. 1. The sensor data may include, for example, red, green, blue (RGB) and depth images of the user's 102 head 106 (i.e., a first physical characteristic). In some implementations, key-points for both left and right ears of the user 102 are extracted and estimated in the global frame of motion tracking. These key-points can be used to formulate ear and head (e.g., the center of the head) coordinates. In some examples, a position of the head includes a center point that is determined based on a mid-point between the ear openings. In some implementations, the head construction module 312 generates a 3D representation of the head of the user 102 using a trained neural network. In some implementations, the head construction module 312 generates a 3D representation of the head of the user 102 using a Multi-View Stereo approach that employs multiple images of a scene to estimate the depth information for each pixel, creating a dense 3D point cloud. The pinnae construction module 322 described below may employ similar techniques to construct a 3D representation of the pinnae of the user.

Apart from using a neural network, we can also use the Multi-View Stereo approach: This approach uses multiple images of a scene to estimate the depth information for each pixel, creating a dense 3D point cloud.

In some implementations, the head selection module 314 compares the 3D user head model to HAT models in the HAT model datastore 340 and selects, based on at least one selection criterion, the HAT model (and respective HRTF) having the most closely matching shape (referred to herein as ‘HAT model A’). In some cases, the at least one selection criterion is tailored to focus on matching shape rather than the size with the user's head (and pinnae as described below) because the best matching, according to shape, HAT model can be scaled to match the user's head (and pinnae).

In an example implementation, the volume space between the 3D models of the user's head (and/or pinnae) and the HAT models in the HAT datastore 340 is minimized using optimization variables. One example of such optimization variables includes: origin of the HAT model: xₒ, yₒ, zₒ; rotation of HAT model about the origin: θₒ, ϕₒ; and a scaling factor of HAT model: PHAT. Using the optimization variables the optimization problem can be framed as a minimization of volume space between the heads (and/or pinnae) of the user and HAT models using xₒ, yₒ, zₒ, θₒ, ϕₒ and ρ_{HAT}. In the example implementation, the HAT model with the smallest volume space is selected.

The head scaling factor module 316 determines a scaling factor to match the head-size of HAT model A with the 3D model of the user head. In some implementation, the optimization approach used by the head selection module 314 (and pinnae selection module 324) also provides the optimal scaling factor ρ_{HAT} as a by-product; however, for clarity, FIG. 3A depicts this computation by the head scaling factor module 316 (and the pinnae scaling factor module 326) separately.

The head frequency warping module 318 adjusts the HRTF associated with HAT model A via frequency warping based on the determined scaling factor to account for the change in the scaling. In some implementations, the head frequency warping module 318 adjusts the HRTF associated with HAT model A by warping the frequency of the HRTF proportionally to the scaling factor. Put another way, when the scaling factor is less than unity, a “stretched” frequency-warping is applied, and when the scaling factor is greater than unity, a “compressed” frequency-warping is applied. In some implementations, frequency warping includes transformation of the frequency spectrum. For example, the frequency spectrum of the audio signal can be either compressed or expanded (e.g., in a non-linear manner) across the frequency axis. In some implementations, frequency warping is applied using the phase vocoder scheme, which employs a short-time Fourier transform (STFT) analysis-modify-synthesis loop for time-scaling signals by means of using different time steps for STFT analysis and synthesis.

Generally, the pinnae function module 320 determines a warped HRTF (for the user's pinnae) in a similar manner to the head function module 310. In some implementations, the pinnae construction module 322 generates a 3D model of the user's pinnae based on collected sensor data. In some implementations, the pinnae construction module 322 receives the sensor data collected from the one or more sensors 112 as described above with reference to FIG. 1. The sensor data may include, for example, RGB and depth images of the user's 102 pinnae 104 (i.e., a second physical characteristic). In some cases, the same or somewhat overlapping sensor data is used in both the head construction module 312 and the pinnae construction module 322. In other cases, these modules use different sensor data collected for either the head or the pinnae of the user.

In some implementations, the pinnae selection module 324 compares the 3D user pinnae model to HAT models in the HAT model datastore 340 and selects, based on at least one selection criterion, the HAT model (and respective HRTF) having the most closely matching shape (referred to herein as ‘HAT model B’). In some cases, the at least one selection criterion is tailored to focus on matching shape rather than the size with the user's pinnae because the best matching HAT model can be scaled to match the user's pinnae.

The pinnae scaling factor module 326 determines a scaling factor to match the pinnae-size of HAT model B with the 3D model of the user pinnae. The pinnae frequency warping module 328 adjusts the HRTF associated with HAT model B via frequency warping based on the determined scaling factor to account for the change in the scaling factors. In some implementations, the pinnae frequency warping module 328 adjusts the HRTF associated with HAT model B by warping the frequency of the HRTF proportionally to the scaling factor.

The combiner module 330 combines the modified (e.g., warped) HRTFs to derive the personalized HRTFs for the user. FIG. 3B depicts an implementation of the combiner module 330 that applies a low-pass filter to the modified HRTF associated with model A (provided via the head function module 310) and a high-pass filter to the modified HRTF associated with model B (provided via the pinnae function module 320). The low-pass filter is applied to the modified HRTF scaled based on the 3D model of the user's head and the high-pass filter is applied to the modified HRTF scaled based on the 3D model of the user's pinnae because a person's head (and torso) primarily affects the lower frequencies of audio signals while a person's pinnae affect the higher frequencies.

The example combiner module 330 implementation depicted in FIG. 3B includes low-pass filter module 332, high-pass filter module 334, and frequency combiner module 336. The high-pass filter module 334 processes the modified (warped) HRTF associated with model B provided via the pinnae function module 320 through a high-pass filter to derive a high-frequency component of the personalized transfer function for the user 102.

Generally, a high-pass filter is an electronic filter that passes signals with a frequency higher than a cutoff threshold frequency (e.g., around 3 kilohertz (kHz)) and attenuates signals with frequencies lower than the cutoff threshold frequency. The amount of attenuation for each frequency can be adjusted depending on the filter design as well as the output requirements (e.g., the type and configuration of the system employing a personalized transfer function to render sound). In some cases, the high-pass filter is modeled as a linear time-invariant system.

The low-pass filter module 332 processes the modified (warped) HRTF associated with model A provided via the head function module 310 through a low-pass filter to derive a low-frequency component of the personalized transfer function for the user 102. Similar to the high-pass filter, a low-pass filter is an electronic filter that passes signals with a frequency lower than the cutoff threshold frequency and attenuates signals with frequencies higher than the cutoff threshold frequency.

Generally, the low-frequency components include frequencies lower than the cutoff threshold frequency while the high-frequency components include frequencies higher than the cutoff threshold frequency. In some implementations, the cutoff threshold frequency is determined or set based on the specific application of the generated personalized impulse response as well as the configuration of the device 110. In some implementations, cutoff threshold frequency is set to a frequency (or range of frequencies) within the bounds of the frequency range for human hearing, from about 20 hertz (Hz) to about 20 kilohertz (kHz); however, the exact frequency response of the low-pass filter and the high-pass filter depend on the design of each filter.

The frequency combiner module 336 is configured to combine the high-frequency component provided from the high-pass filter module 334 and the low-frequency component provided from the low-pass filter module 332 into the resulting personalized transfer function for the user 102. In some implementations, the modules 332, 334, and 336 (or at least one module thereof is) are executed via an electronic processor of a device, such as the device 110 described above with reference to FIG. 1 or computing device 810 described below with reference to FIG. 8. In some implementations, the modules 332, 334, and 336 (or at least one module thereof is) are provided via a back-end system, such as the back-end system 630 described below with reference to FIG. 6, and the device (e.g., device 110 or computing device 810) is configured to communicate with the back-end system via a network, such as the communications network 610 described below with reference to FIG. 6.

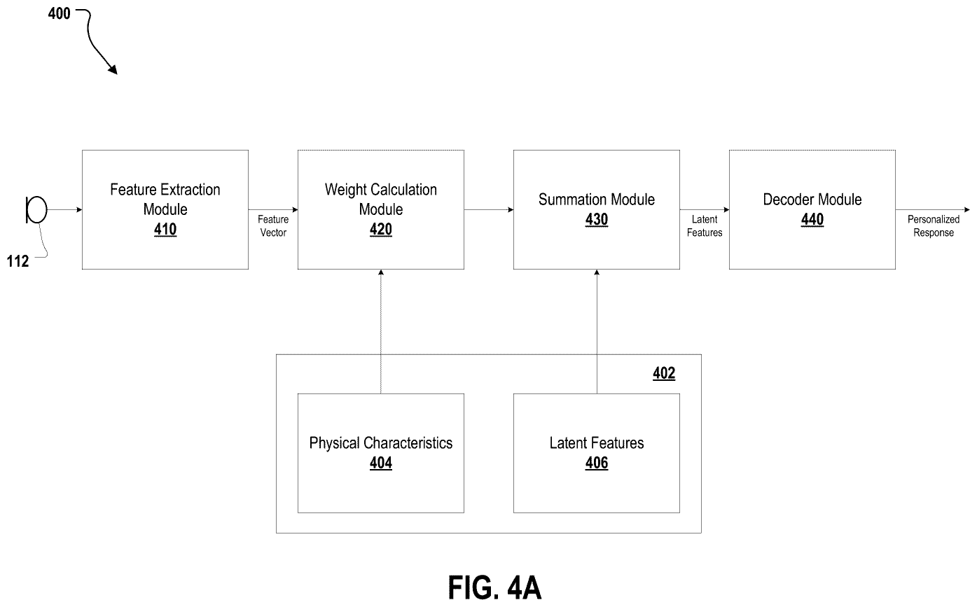

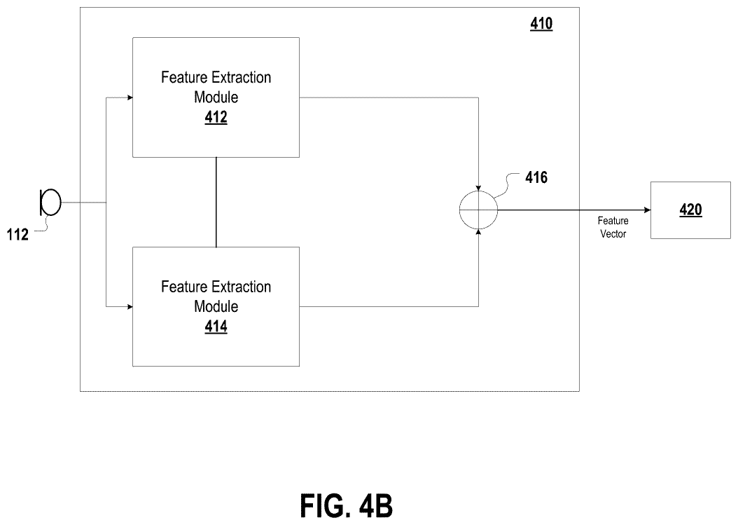

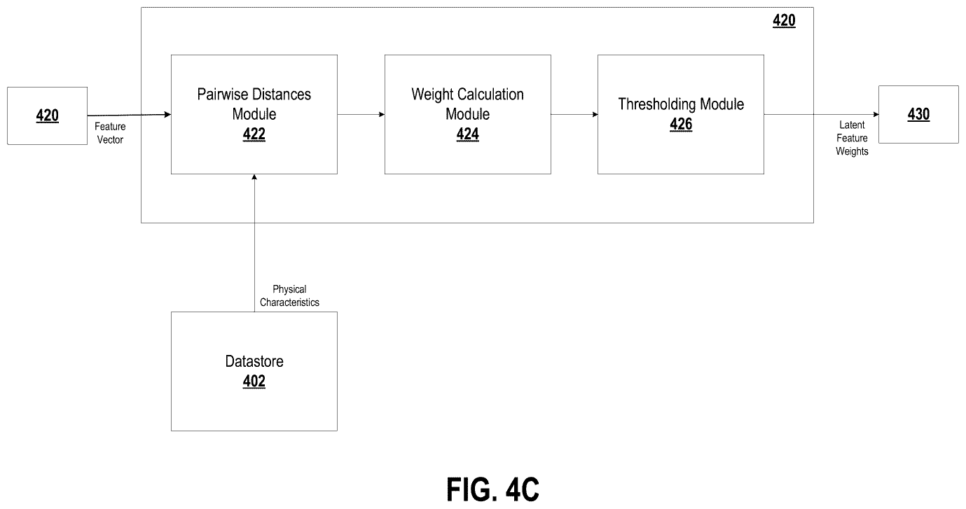

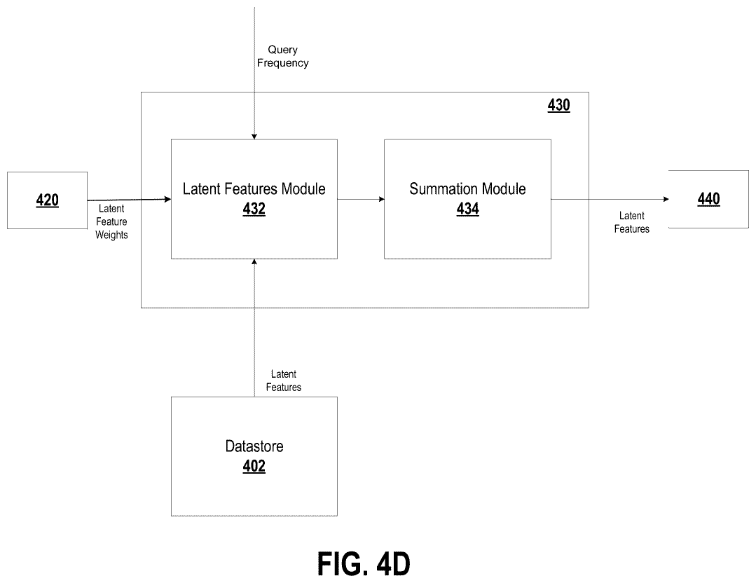

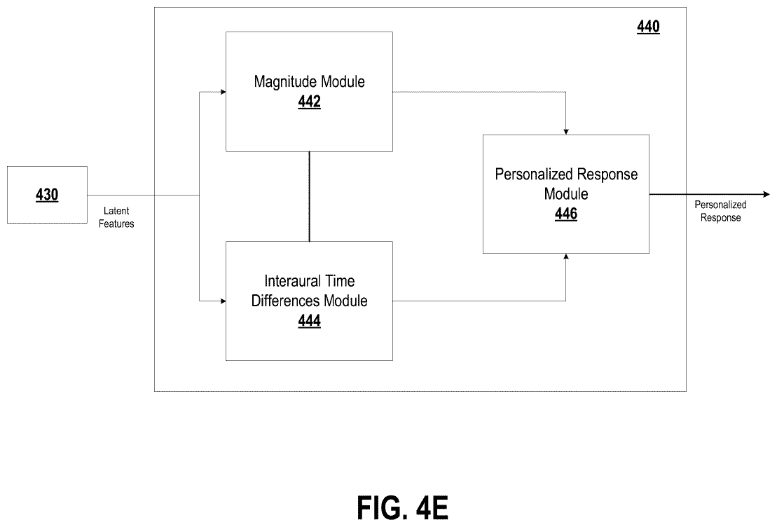

FIGS. 4A-4D are block diagrams depicting another example architecture 400 for the described audio signal personalization system. The example architecture 400 can be employed to combine structural transfer function components of a listener by using a latent space representation of transfer functions. In some implementations, a personalized transfer function (or pHRTF) is determined via the example architecture 400 using data collected from a scan of the user's head. In some cases, the determined transfer function is stored as latent features in a memory (or a datastore) as opposed to storing the raw HRTF, which results in memory savings when the latent features have less dimensionality than the spatial grid.

A spherical harmonics basis can be used to approximate functions on a sphere. Accordingly, the HRTF of the user may be denoted as a complex valued function: H(ƒ, θ, ϕ), where θ and ϕ are the azimuth and elevation angles, respectively. For a given frequency f₀, the magnitude of the HRTF, |H(ƒ, θ, ϕ)|, is a real function defined on a sphere and can be represented using spherical harmonics. The spherical harmonics basis is a “general” basis that can be used to represent “generic” functions defined on a sphere. In some cases, a user's HRTF is defined according to a latent space representation of |H(ƒ, θ, ϕ)| that is specific to the HRTF dataset (e.g., captured spatial modes specific to a given HRTF dataset).

In some implementations, an HRTF is represented within the components and module of the example architecture 400 using spatial principal component analysis according to:

$$\vert H ( f , θ , ϕ ) \vert = {\sum }_{k = 1}^{D} {d}_{k} ( f ) {W}_{k} ( θ , ϕ ) + B ( f , θ , ϕ )$$

where Wₖ(θ, ϕ) are the spatial basis functions, dₖ(ƒ) are the frequency dependent basis coefficients and B(ƒ, θ, ϕ) is a biased term. Accordingly, an approach similar to principal component analysis may be employed with the example architecture 400 to compute the basis functions, the coefficients, and the bias from a given HRTF dataset. For example, the latent space representation of an HRTF magnitude for a given frequency f₀ can be represented as [d₁(f₀), d₂(f₀), . . . ]. As such, a weighted averaging of such feature vectors is equivalent to a weighted averaging applied directly on HRTF magnitudes and then computing the basis coefficients (due to the linearity of principal component analysis), which may result in nonsensical HRTFs. However, variational autoencoders produce improved results when vector arithmetic is performed in the latent space. Accordingly, the example architecture 400 employs a variational autoencoder (VAE) to obtain a latent space representation of the HRTF magnitude. Specifically, an HRTF magnitude feature vector may be used for the left ear defined on a directional grid that follows:

$${x}_{L} = [ \vert H ( {f}_{0} , {θ}_{1} , {ϕ}_{1} ) \vert , \vert H ( {f}_{0} , {θ}_{2} , {ϕ}_{2} ) \vert , … \vert H ( {f}_{0} , {θ}_{D} , {ϕ}_{D} ) \vert ]$$

The HRTF magnitude feature vector for the right ear X_{R} may be defined similarly. In some implementations, the two vectors, x_{L} and x_{R}, are stacked to form the overall HRTF feature tensor:

$$x = [ \begin{matrix}{x}_{L} \\ {x}_{R}\end{matrix} ]$$

In some implementations, the HRTF tensor is encoded to a latent vector, z, using an encoder: z=Encoder(x). In some implementations, an HRTF magnitude tensor is generated from the latent space vector using a decoder: x=Decoder(z). This VAE is employed to control the distribution of the latent features z. For example, during the training of a neural network training, the latent features are distributed as isotropic Gaussian random variables: z˜N(0, I), by having a term in the loss function that quantifies how similar the distribution of the latent features is to an isotropic Gaussian random variable (the KL Divergence). In some cases, the other term in the loss function is a reconstruction loss term.

In some implementations, the VAE is trained in an unsupervised manner using an already existing HRTF dataset. To increase training set size, 3D morphable head and ear models can be generated. The generated 3D models can be used to compute HRTFs via acoustic simulations that use boundary element method (BEM) or finite element method (FEM). The produced realistic synthetic HRTF data can be used for training.

Determining an HRTF estimation can be viewed as a “cross-domain” problem. As described above, how the head and ears transform sound waves can be determined based on the geometry of the head and ears (note that the torso can also be included in this approach). Accordingly, in some implementations, the geometry of the head and ears is represented to facilitate this cross-domain determination. As used herein, the term “physical characteristics” includes, but are not limited to, the characteristics or features of the head and ears as well areas of the torso such as the shoulders.

As depicted in FIG. 4A, the example architecture 400 includes feature extraction module 410, weight calculation module 420, summation module 430, decoder module 440, and subject datastore 402. The feature extraction module 410 extracts physical characteristics based on the image data received from one or more sensors. These physical characteristics may include, for example, face and ear landmarks or anthropometric measurements of the head and ears. For example, as described in the example architectures 200 and 300 above, a 3D head and ear model and/or scan of the user can be determined using the image data. In some cases, the user may employ a device, such as the device 110 described above with reference to FIG. 1, to capture image data of his or her head, ears, shoulders, and so forth using one or more sensors, such as the one or more sensors 112. The extraction module 410 is described in more detail below with reference to FIG. 4B.

The weight calculation module 420 assigns weights to each subject in subject datastore 402. In some cases, the weights are assigned based on the similarity of the physical characteristics of the user (as extracted by the feature extraction module 410) to the physical characteristics 404 of each subject stored to the subject datastore 402 and according to a set threshold value. For example, a higher weight is assigned to subjects that have physical characteristics that are more similar to that of the user. The subject datastore 402 includes, for example, measured physical characteristics 404 of human subjects and latent features 406 (e.g., the transfer functions) associated with these physical characteristics 404 (e.g., determined with data collected in an anechoic chamber). The extraction module 420 is described in more detail below with reference to FIG. 4C.

The summation module 430 combines the latent features 406 (e.g., transfer functions) associated with the subjects in the subject datastore 402 based on the assigned weighted values. For example, in some implementations, the summation module 430 is configured to combine the latent space representations (i.e., vectors) of the HRTF magnitudes for each of the subjects using the assigned weight values. The summation module 440 is described in more detail below with reference to FIG. 4D.

The decoder module 440, which may include a trained artificial intelligence AI model such as a trained AI model such as a neural network, is employed to reconstruct a pHRTF magnitude vector for the user across a predetermined direction grid from the combined latent space representation. In some cases, the decoder module 440 repeats the HRTF construction for query frequencies on a frequency grid to form the HRTF spectra for each direction on the direction grid (see FIG. 4E). Moreover, the interaural time differences (ITD) for each direction on the grid may be separately estimated. For example, for each direction in the grid, the personalized HRTF magnitude and the estimated ITD are used to reconstruct a personalized HRIR for the user using a minimum-phase filter cascaded with a pure delay. ITD is a binaural cue, especially relating to lateral localization of auditory events. The decoder module 440 is described in more detail below with reference to FIG. 4E.

FIG. 4B depicts an implementation of the feature extraction module 410. As depicted, the feature extraction module 410 includes head feature extraction module 412, and ear feature extraction module 414, and combiner module 416. In some implementations, the feature extraction module 410 obtains physical characteristics of the user by extracting anthropometric measurements derived from 3D head and ear meshes. In some implementations, the feature extraction module 410 employs a related approach that includes extracting 3D semantic key points from the head and ear meshes. In some implementations, the feature extraction module 410 determines a feature vector that represents the geometry and shape of the user's head via the head feature extraction module 412 and one of the user's ears via the ear feature extraction module 414.

In some implementations, the ear feature extraction module 414 determines a transfer function for one of the user's ears (e.g., using the head and left ear physical characteristics), a reflection of the transfer function with respect to the median plane is used to construct the transfer function for the other ear. Example physical characteristics that can be extracted include, but are not limited to, anthropometric measurements of the head (e.g., head width, height, depth), anthropometric measurements of the pinnae (e.g., the pinna width and height, the cavum concha width and height). In some implementations, images of a user's head and ear are used to reconstruct a mesh, which is provided to a vision encoder and used to compute mesh embeddings that are used as physical characteristics. The combiner module 416 combines (e.g., concatenates) the feature vectors into a combined physical characteristics vector v_{q}.

FIG. 4C depicts an implementation of the weight calculation module 420. As depicted, the weight calculation module 420 includes pairwise distances module 422, weight calculation module 424, and thresholding module 426. As described above, the weight calculation module 420 is configured to determine weights for each human subject stored in the database 402 based on the physical characteristics extracted for the user as represented by the feature vector v_{q}.

In some implementations, the weight calculation module 420 determines weights based on the determined physical characteristics vg and physical characteristics 404 of the human subjects, represented as v₁, v₂, v₃ . . . . In some implementations, the weight calculation module 420 determines these weights based on a distance between the physical characteristics. For example, the pairwise distances module 422 represents a distance metric by the Euclidean distance d(x, y)=∥x−y∥₂ (other example representations, such as L1 distance, may also be used) when d(x, y) represents a distance metric between the physical characteristic vectors x and y. In some examples, the distances between the query physical characteristics and the features of the human subjects stored in the subject datastore 402, {d₁, d₂ . . . , dₘ} (dᵢ≥0), is determined by the pairwise distances module 422. The weights for each human subject can then be formed, by weight calculation module 424, according to:

$${w}_{i} = \frac{{d}_{i}}{{\sum }_{k} {d}_{k}}$$

(with this approach, the weights sum to 1.0).

In other implementations, the weight calculation module 420 determines weights by modeling the probability that a query feature vector v_{q} would “pick” feature vector vᵢ as its neighbor, as a conditional probability p_{i|q} according to:

$${p}_{i \vert q} = \frac{exp ( - \frac{{d}^{2} ( {v}_{i} , {v}_{q} )}{2 {σ}^{2}} )}{{\sum }_{k} exp ( \frac{{d}^{2} ( {v}_{i} , {v}_{q} )}{2 {σ}^{2}} )}$$

In some implementations, the weight calculation module 420 uses wᵢ=p_{i|q} (note again that the weights sum to 1.0). Modeling the weights as a probability distribution has some advantages. For example, p_{i|q} is similar all i (as in p_{i|q} is nearly uniform—quantified by a high entropy). In some cases, the queried vector is not close to any other vectors in the database because, for example, the queried vector is an outlier or has a similar distance to most of the database vectors. The latter may be unlikely in a high dimensional feature space. In such cases, when the feature vector is an outlier, further automated checks can be done on the physical characteristics to detect errors or to determine. A correction mechanism can be used, or the user can be prompted to re-scan their head and ears.

In some implementations, after the weights are calculated, the thresholding module 426 is configured to set weights to zero that are below a threshold to limit the number of human subjects used for latent space fusion and to keep only the major contributors. Removing the weights below the threshold also decreases the chances that a nonsensical HRTF is produced after latent space fusion and decoding. In some implementations, the weights are re-normalized to sum to 1.0.

FIG. 4D depicts an implementation of the summation module 430. As depicted, the summation module 430 includes latent features module 432 and summation module 434. As described above, the summation module 430 combines, in latent space, the HRTF for the human subjects stored to the subject datastore 402 given latent feature weights provided by the calculation module 420. In some implementations, the latent features module 432 is configured to receive the latent space vectors, z₁, z₂, z₃, . . . , for the queried frequency are provided from the subject datastore 402. In some cases, these frequencies are computed from an HRTF dataset by running inference with the VAE encoder and saving the latent feature outputs to a database (e.g., subject datastore 402). In some implementations, the summation module 434, performs a weighted summation in the latent space to obtain the pHRTF latent space vector z_{q} according to:

$${z}_{q} = {\sum }_{k} {w}_{k} {z}_{k}$$

In some implementations, the HRTFs of the human subjects are encoded to the latent space and stored to the subject datastore 402. Storing these HRTFs in such a manner (e.g., the latent space features are stored in the database instead of the raw HRTFs) removes unnecessary computation as the computation can be performed once offline. Moreover, the latent space features often have lower dimensionality than the HRTFs, which saves database memory. Therefore, in some cases, the database includes the physical characteristics and the latent space HRTFs of the human subjects.

FIG. 4E depicts an implementation of the decoder module 440. As depicted, the decoder module 440 includes magnitude module 442, interaural time differences module 444, and personalized response module 446. As described above, the decoder module 440 constructs a personalized HRIR for the user using the personalized transfer function (e.g., an HRTF) latent space vector z_{q}.

In some implementations, the magnitude module 442 determines the pHRTF magnitude by computing the latent space pHRTF feature vector: z_{q}. In some implementations, the magnitude module 442 employs a VAE decoder is used to reconstruct the pHRTF magnitude tensor [symbol] for a specific frequency fᵢ according to:

$$= Decoder ( {z}_{q} ) = [ ]$$

Where x_{q,L} is the pHRTF magnitude for the left ear:

$${x}_{q , L} = [ \vert ( {f}_{i} , {θ}_{1} , {ϕ}_{1} ) \vert , \vert ( {f}_{i} , {θ}_{2} , {ϕ}_{2} ) \vert , … \vert ( {f}_{i} , {θ}_{D} , {ϕ}_{D} ) \vert ]$$

Note that [symbol] includes the pHRTF magnitudes for both ears (e.g., it has two channels). The process can then be repeated for a grid of frequencies [f₁, f₂ . . . , fₙ]. As a result, for each spatial grid point, the pHRTF magnitude spectra for both ears is determined.

In some implementations, the personalized response module 446 determines, for each spatial grid point, a minimum phase filter impulse response using the pHRTF magnitude spectra. However, in some cases, the personalized response module 446 corrects ITD cues in the pHRTFs. In some cases, the interaural time differences module 444 reproduce the ITD cue by cascading a linear phase or a pure delay component corresponding to the ITD can be to the minimum phase filter for the left or right ear. In some implementations, the interaural time differences module 444 determines the ITD from the 3D head scan or from the determined physical characteristics to reproduce the ITD cue with a delay component. In some implementations, the interaural time differences module 444 determines the ITD using head anthropometric features (e.g., head width, height, and length) . . . . In some implementations, the interaural time differences module 444 employs a regression model to relate the measured ITD at a certain spatial grid point to head anthropometric features.

In some implementations, the modules 410, 412, 414, 416, 420, 422, 424, 426, 430, 432, 434, 440, 442, 444, and 446 (or at least one module thereof is) are executed via an electronic processor of a device, such as the device 110 described above with reference to FIG. 1 or computing device 810 described below with reference to FIG. 8. In some implementations, the modules 410, 412, 414, 416, 420, 422, 424, 426, 430, 432, 434, 440, 442, 444, and 446 (or at least one module thereof is) are provided via a back-end system, such as the back-end system 630 described below with reference to FIG. 6, and the device (e.g., device 110 or computing device 810) is configured to communicate with the back-end system via a network, such as the communications network 610 described below with reference to FIG. 6.

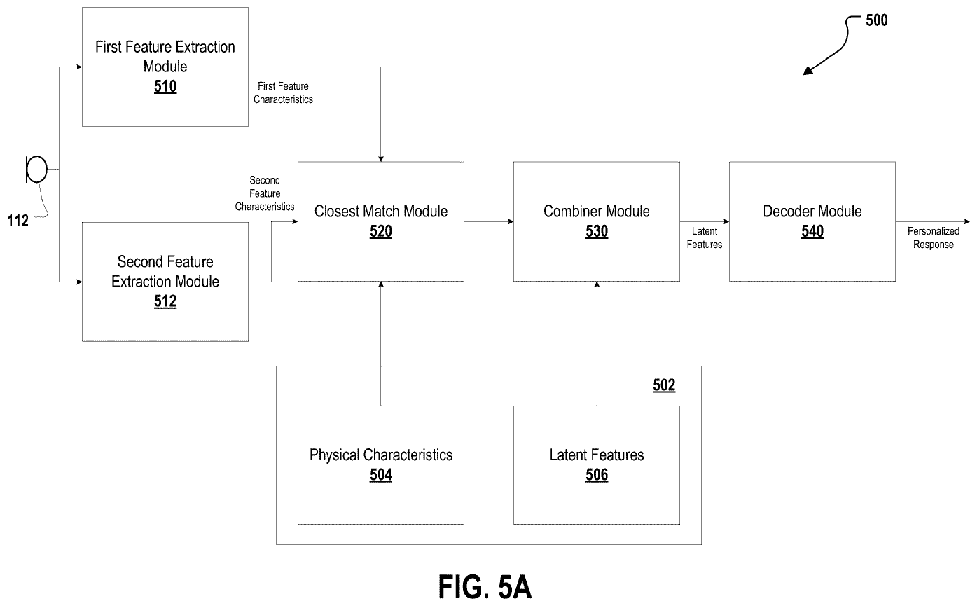

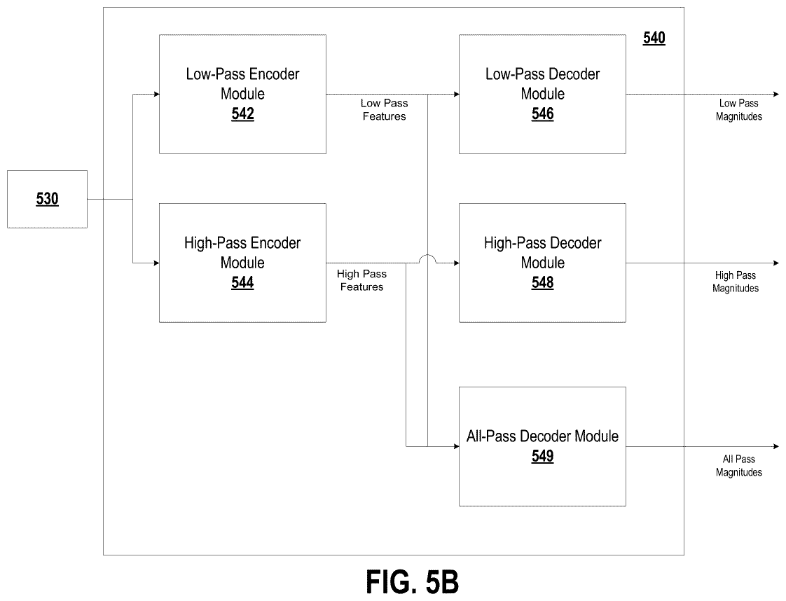

FIGS. 5A and 5B are block diagrams depicting another example architecture 500 for the described audio signal personalization system. The example architecture 500 can be employed to determine a personal transfer function for a user through mixed structural modeling that combines structural transfer function components of a listener by using a latent space representation of transfer functions. In some cases, mixed structural modeling can be used to analyze data that is organized in a hierarchical or multilevel structure (e.g., a transfer function), where observations within a cluster are dependent, but clusters are independent of each other. Mixed models are also known as multilevel or hierarchical models.

As depicted in FIG. 5A, the example architecture 500 includes first feature extraction module 510, second feature extraction module 512, closest match module 520, combiner module 530, decoder module 540, and subjects datastore 502. Similar to the subject datastore 402 described above with reference to FIGS. 4A-4E, the subjects datastore 502 includes measured physical characteristics 504 of human subjects and HRTFs associated with these physical characteristics referred to herein as latent features 506 (e.g., determined with data collected in an anechoic chamber).

The first feature extraction module 510 and the second feature extraction module 512 extracts physical characteristics that are specific to an area of the user based on the image data received from one or more sensors. For example, the first feature extraction module 510 may be configured to extract information related to the user's head while the second feature extraction module 512 is configured to extract information related to a user's ear(s) or pinnae. Physical characteristics may include, for example, face and ear landmarks or anthropometric measurements of the head and ears. For example, as described in the example architectures 200, 300, and 400 above, a 3D head and ear model and/or scan of the user can be determined using the image data. In some cases, the user may employ a device, such as the device 110 described above with reference to FIG. 1, to capture image data of his or her head, ears, shoulders, and so forth using one or more sensors, such as the one or more sensors 112. Additional feature extraction modules may be included to extend the process provided by architecture 500 to include the user's torso effects on their transfer function.

In some implementations, features related to geometry and shape are extracted from the head and ears (e.g., the left ear) of the 3D scan (e.g., by the first feature extraction module 510 and/or the second feature extraction module 512). Once the pHRTF is determined for the left ear using the head and left ear physical characteristics, a reflection of the pHRTF with respect to the median plane may be used to construct the pHRTFs of the right ear.

The closest match module 520 is configured to select a human subject from the subjects datastore 502 that is the closest match to each of the features extracted by the first feature extraction module 510 and the second feature extraction module 512. For example, the closest match module 520 may match the physical characteristics of the user's head provided by the first feature extraction module 510 with a first subject in the subjects datastore 502 and the physical characteristics of the user's ears provided by the second feature extraction module 512 with a second subject in the subjects datastore 502. The first subject and second subject may be the same subject but in many cases these subjects will be different people. In some cases, pre-computed latent features 506 for the HRTF magnitudes for the first subject and the second subject are stored to the subjects datastore 502. In some cases, for each human subject, latent features 506 that represent the head's contribution to the HRTF and also the same for the ear's contribution are stored to the subjects datastore 502.

The combiner module 530 combines the latent features 506 for the first subject matching the first feature (e.g., the user's head) and the latent features 506 for the second subject matching the second feature (e.g., the user's ears). In some cases, the latent features 506 are combined and pass through a composite combine and decode network to obtain the pHRTF magnitudes for the user.

FIG. 5B is a diagram illustrating an example implementation of the decoder module 540 that employs a frequency band splitting VAE architecture. As depicted in FIG. 5A, the example VAE architecture includes low-pass encoder module 542, high-pass encoder module 544, low-pass decoder module 546, high-pass decoder module 548, and all-pass decoder module 549. The VAE architecture may be tailored to learn separate latent features for the contribution of the ears and heads to the HRTFs. For example, because the pinna contributes to the portion of the HRTF above 3 kHz, the head can contribute to localization cues at low and high frequencies, but the majority of the contribution is assumed to lower frequencies. Accordingly, architecture can learn latent features for low frequencies (<3 kHz) and high frequencies (>3 kHz) and the ability to combine and decode the combination of these latent features. Note that the combination of physical structures like the ear and head does not imply the superposition of their acoustic fields. Therefore, combining raw HRTFs or their magnitudes might not result in sensical HRTFs. However, the pinna and head's contributions may be combined in the latent space. However, this will not necessarily translate to superimposition of raw HRTFs or their magnitudes.

In some cases, the magnitude of the HRTF (at a single frequency) may be represented as a vector. Inference may be run with the low-pass encoder module 542 to determine the low-pass latent space vector according to:

z_{LP}=Encoder_{LP}(x)

Similarly, inference may be run with the high-pass encoder module 544 to determine the high-pass latent space vector according to:

z_{HP}=Encoder_{HP}(x)

In some implementations, the low-pass decoder module 546 recovers the low-pass portion of the HRTF according to:

[symbol]

=Decoder_{LP}(z_{LP})

Similarly, in some implementations, the high-pass decoder module 548 recovers the high-pass portion of the HRTF:

[symbol]

=Decoder_{HP}(z_{HP})

The low-pass portion, x_{LP}, is equal to x if the frequency associated with x, fₓ is smaller than a cutoff frequency (e.g., 3 kHz), f_{c}=cutoff frequency. The high-pass portion is defined in a similar manner but vice versa:

$$\begin{matrix}{x}_{LP} = \{ \begin{matrix}x if {f}_{x} < {f}_{c} \\ {x}_{LP - R} if {f}_{x} \geq {f}_{c}\end{matrix} \} \\ {x}_{HP} = \{ \begin{matrix}{x}_{HP - R} if {f}_{x} < {f}_{c} \\ x if {f}_{x} \geq {f}_{c}\end{matrix} \}\end{matrix}$$

where x_{LP-R} is the residual low-pass component for query frequencies above f_{c}, x_{HP-R} is the residual high-pass component for query frequencies below f_{c}, and x_{LP} and x_{HP} are estimates of the above.

In some implementations, the all-pass (AP) decoder module 549 combines a low-pass and a high-pass latent vector and decodes them to form a full-band HRTF magnitude vector according to:

$$\begin{matrix}{z}_{FB} = [ \begin{matrix}{z}_{LF} \\ {z}_{HF}\end{matrix} ] \\ \hat{x} = {Decoder}_{AP} ( {z}_{FB} )\end{matrix}$$

where x is an estimate of x.

In some implementations, the low-pass encoder module 542 and the high-pass encoder module 544 employ encoders that have been trained to understand latent representations of HRTF magnitudes. In some implementations, the all-pass decoder module 549 employs a decoder trained to combine these representations to reconstruct the HRTF magnitude. In some cases, an autoencoder with a single encoder and a single decoder has a KL-divergence loss component so that the latent features have a Gaussian distribution: z˜N(0, I). In some cases, a reconstruction loss component is used so that the latent features, once decoded, can reconstruct the input. Multiple encoders and multiple decoders may also be used.

In some implementations, various loss components describe the loss functions used for training. For example, a KL-divergence term, L_{kl-LP}(z_{LP}), quantifying the divergence of z_{LP} from a Gaussian distribution. In some cases, a reconstruction loss term L_{rec-LP}(x_{LP}, [symbol] ), that quantifies how well x_{LP} is reconstructed by the low-pass decoder, is employed. The high-pass counterparts may be defined as, L_{kl-LP}(z_{HP}) and L_{kl-HP}(x_{HP}, [symbol] ). A reconstruction loss component for the all-pass decoder output may also be defined according to L_{rec-AP}(x, \hat{x}).

In some implementations, the low-pass encoder and decoder's loss function (used to optimize the weights of the low-pass encoder and decoder via backpropagation) is defined according to:

$${L}_{total - Lp} = I ( {f}_{x} < {f}_{c} ) {L}_{rec - LP} ( {x}_{LP} , ) + {L}_{kl - LP} ( {z}_{LP} ) + {L}_{rec - AP} ( x , \hat{x} )$$

where:

$$I ( x ) = \{ \begin{matrix}1 if x = True \\ 0 if x = False\end{matrix} \}$$

Therefore, in some implementations, the low-pass encoder module 542 and low-pass decoder module 546 employ encoder and decoders respectively that are trained to produce low-pass latent features with the desired distribution and encodes the low-pass component of the HRTF. The all-pass reconstruction term may also be used to reconstruct the original input from the low-pass and high-pass latent features combined. In some cases, the low-pass reconstruction loss is non-zero for inputs with frequencies fₓ<f_{c}. In some cases, the inputs with high frequencies using the low-pass encoder and decoder are discarded. For inputs with fₓ≥f_{c}, the z_{LP} encoding allows for improved reconstruction of x when combined with z_{HP}. In some cases, a loss component is introduced to limit the value of [symbol] when fₓ≥f_{c}. Accordingly, the low-pass encoder and decoder can intrinsically learn more about the relation between the frequency fₓ, and the spatial structure of the HRTF at different frequencies.

In some implementations, the loss for the high-pass encoder, employed by the high-pass encoder module 544 and the high-pass decoder, employed by the high-pass decoder module 548, is defined as follows:

$${L}_{total - Lp} = I ( {f}_{x} \geq {f}_{c} ) {L}_{rec - HP} ( {x}_{HP} , ) + {L}_{kl - HP} ( {z}_{LP} ) + {L}_{rec - AP} ( x , \hat{x} )$$

In some cases, the loss of the all-pass decoder, employed by the all-pass decoder module 549, is defined according to:

$${L}_{total - AP} = {L}_{rec - AP} ( x , \hat{x} )$$

Accordingly, the all-pass decoder can reconstruct the original input from the low-pass and high-pass latent features.

As described above, the low-pass and high-pass latent features from different human subjects can be combined, combiner module 530, to form the pHRTF for the user. In some cases, the subjects and latent space features are selected from the subjects datastore 502 using the physical characteristics determined from the 3D. For example, the measurement set associated with a subject may be selected based on similar visual head features to the user (measurement set i) and the measurement set associated with another subject (or the same subject) may be selected based on similar visual ear features to the user (measurement set j).

In some implementations, to construct a pHRTF magnitude for a certain query frequency f_{q} the low-pass latent feature for the query frequency for measurement set i, z_{LP.i}(f_{q}) is selected. In some implementations, the high-pass latent feature for the query frequency for measurement set j, z_{HP.j}(f_{q}) is also selected. These can then be combined and decoded to form the pHRTF vector at the query frequency according to:

$$\begin{matrix}{z}_{FB} ( {f}_{q} ) = [ \begin{matrix}{z}_{LP , i} ( {f}_{q} ) \\ {z}_{HP , j} ( {f}_{q} )\end{matrix} ] \\ \hat{x} {f}_{q} = {Decoder}_{AP} ( {z}_{FB} ( {f}_{q} ) )\end{matrix}$$

The above algorithm can be applied for a vector of query frequencies to obtain the pHRTF magnitude spectra for each point on the spatial grid.

The pHRIR can be reconstructed using the pHRTF magnitude spectra. For example, the pHRIR may be represented as a minimum phase filter cascaded with a pure delay. The pure delay filter can be based on the estimated ITD.

As described above, the HRTF magnitude vectors can be encoded per frequency. For example, the left and overall HRTF magnitude tensor may be constructed respectively according to:

$$\begin{matrix}{x}_{L} = [ \vert {H}_{L} ( {f}_{0} , {θ}_{1} , {ϕ}_{1} ) \vert , \vert {H}_{L} ( {f}_{2} , {θ}_{0} , {ϕ}_{0} ) \vert , … \vert {H}_{L} ( {f}_{0} , {θ}_{D} , {ϕ}_{D} ) \vert ] \\ x = [ \begin{matrix}{x}_{L} \\ {x}_{R}\end{matrix} ]\end{matrix}$$

In some cases, x is then encoded to a latent space. An alternative approach may construct the HRTF vector across frequencies, for one direction (θ₀, ϕ₀) according to:

$$\begin{matrix}{x}_{L} = [ \vert {H}_{L} ( {f}_{1} , {θ}_{0} , {ϕ}_{0} ) \vert , \vert {H}_{L} ( {f}_{2} , {θ}_{0} , {ϕ}_{0} ) \vert , … \vert {H}_{L} ( {f}_{N} , {θ}_{0} , {ϕ}_{0} ) \vert ] \\ x = [ \begin{matrix}{x}_{L} \\ {x}_{R}\end{matrix} ]\end{matrix}$$

In some implementations, the decoder module 540 employs a frequency splitting VAE architecture. In some cases, the remainder of the methodology is analogous to what is described above related to the frequency band splitting VAE architecture; however, the networks are configured to learn latent representations of HRTF spectrum structure rather than a spatial structure.

In some implementations, the pHRTF magnitude is constructed followed by the full pHRIR using a minimum phase filter and a pure delay. In some cases, the full complex valued pHRTF may also be constructed using the frequency splitting VAE architecture. In such examples, the HRTF is split into its real and imaginary components to form the input tensor to the network. For example, x_{L} is a complex valued vector that contains the complex HRTF values at a certain frequency, for the left ear according to:

$${x}_{L} = [ \vert {H}_{L} ( {f}_{0} , {θ}_{1} , {ϕ}_{1} ) \vert , \vert {H}_{L} ( {f}_{i} , {θ}_{2} , {ϕ}_{2} ) \vert , … \vert {H}_{L} ( {f}_{i} , {θ}_{D} , {ϕ}_{D} ) \vert ]$$

x_{R} can be defined similarly for the right ear. In some implementations, the input tensor is constructed by stacking Re{x_{L}}, Im{x_{L}}, Re{x_{R}}, Im{x_{R}}, where Re{.} and Im{.} denote taking the real and imaginary parts of each element of a vector.

One advantage of this approach is that when the complex valued pHRTF is estimated there is no need to reconstruct the pHRIR using the minimum phase approach. Instead, the inverse FFT of the constructed pHRTF can be used. Another advantage included taking further measures to aid the networks in learning to construct sensical HRTFs. For example, physics informed neural network training can be applied, which can be done during training by computing the low-pass and high-pass latent features from two different measurement sets i, j:

z_{LP,i}=Encoder_{LP}(xᵢ)

z_{HP,i}=Encoder_{HP}(xᵢ)

z_{LP,j}=Encoder_{LP}(xⱼ)

z_{HP,j}=Encoder_{HP}(xⱼ)

The low-pass and high-pass latent features from the two measurement sets can then be mixed and the combination decoded to form a novel HRTF according to:

$$\begin{matrix}{z}_{FB , novel} = [ \begin{matrix}{z}_{LP , i} \\ {z}_{HP , j}\end{matrix} ] \\ \hat{x} = {Decoder}_{AP} ( {z}_{FB} ( {f}_{q} ) )\end{matrix}$$

In some implementations, the network is aided in learning to construct sensical HRTFs, that is, \hat{x} should make sense from a physics point of view. Since HRTFs can be regarded as the sound field around the head, they should obey the Helmholtz equation (the equation that describes acoustic wave propagation). A loss component L_{PDE}(\hat{x}) that quantifies the deviation of \hat{x} from the Helmholtz equation may also be introduced. L_{PDE}(\hat{x}) can then be used for updating the weights of the low-pass encoder, high-pass encoder and the all-pass decoder to guide the networks in constructing HRTFs that make sense physically.

In some implementations, the modules 510, 512, 520, 530, 540, 542, 544, 546, 548, and 549 (or at least one module thereof is) are executed via an electronic processor of a device, such as the device 110 described above with reference to FIG. 1 or computing device 810 described below with reference to FIG. 8. In some implementations, the modules 510, 512, 520, 530, 540, 542, 544, 546, 548, and 549 (or at least one module thereof is) are provided via a back-end system, such as the back-end system 630 described below with reference to FIG. 6, and the device (e.g., device 110 or computing device 810) is configured to communicate with the back-end system via a network, such as the communications network 610 described below with reference to FIG. 6.

FIG. 6 depicts an example environment 600 that can be employed to execute implementations of the present disclosure. The example environment 600 includes computing devices 602, 604, 606, 608; a back-end system 630, and a communications network 610. The communications network 610 may include wireless and wired portions. In some cases, the communications network 610 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 610 may also include future developed networks. In some implementations, the communications network 610 includes the Internet, an intranet, an extranet, or an intranet and/or extranet that is in communication with the Internet. In some implementations, the communications network 610 includes a telecommunication or a data network.

In some implementations, the communications network 610 connects web sites, devices (e.g., the computing devices 602, 604, 606, and 608) and back-end systems (e.g., the back-end system 630). In some implementations, the communications network 610 can be accessed over a wired or a wireless communications link. For example, mobile computing devices (e.g., the computing device 602 can be a smartphone device and the computing device 606 can be a tablet device), can use a cellular network to access the communications network 610. In some examples, the users 622, 624, 626, and 628 interact with the system through a graphical user interface (GUI) (e.g., the user interface 825 described below with reference to FIG. 8) or client application that is installed and executing on their respective computing devices 602, 604, 606, or 608.

In some examples, the computing devices 602, 604, 606, and 608 provide viewing data (e.g., a prompt move the respective device while the device broadcasts audio) to screens with which the users 622, 624, 626, and 626, can interact. In some examples, the computing devices 602, 604, 606, and 608 broadcast and record audio signals and then provide the recorded signals to the back-end system 630, which is configured to determine a personalized impulse response according to implementations of the present disclosure. In some examples, the computing devices 602, 604, 606, and 608 are configured to determine a personalized impulse response and provide audio signals generated with the personalized impulse response (or the related personalize transfer function) to the respective users 622, 624, 626, and 626 according to implementations of the present disclosure.

In some cases, the computing devices 602, 604, 606, and 608 are configured to determine a personalized impulse response for multiple users according to implementations of the present disclosure. In such cases, the computing devices 602, 604, 606, and 608 may be configured to provide an audio stream (e.g., to headphones or a loudspeaker) generated based on the user's personalized impulse response or personalized transfer function. In some cases, the computing devices 602, 604, 606, and 608 may be configured to simultaneously provide audio signals generated for multiple users based on the user's respective personalized impulse response. For example, the computing devices 602, 604, 606, and 608 may be configured to provide a first audio signal to a first user (e.g., via a first pair of connected headphones) generated based on a first personalized impulse response associated with the first user while also providing a second audio signal to a second user (e.g., via a second pair of connected headphones) generated based on a second personalized impulse response associated with the second user.

In some cases, the computing devices 602, 604, 606, and 608 are configured to determine a single impulse response or a single transfer function for multiple users according to implementations of the present disclosure. In such cases, the computing devices 602, 604, 606, and 608 are configured provide instructions to move the device in a similar manner described above with reference to FIG. 1; however, the captured the audio data, video data, and/or IMU data includes information relating to more than one individual and/or their position relative to one other and/or other objects in the space in a particular environment. For example, the individuals may take scans based on how they most often sit in a room when listening to an audio system. In such cases, the computing devices 602, 604, 606, and 608 may be configured to generate an audio stream based on the single impulse response, which may then be provided to, for example, the audio system (e.g., via the communications network 610 or directly via BLUETOOTH).

In some implementations, the computing devices 602, 604, 606 and 608 are substantially similar to the computing device 810 described below with reference to FIG. 8. The computing devices 602, 604, 606, and 608 may include (e.g., may each include) any appropriate type of computing device, such as a desktop computer, a laptop computer, a handheld computer, a tablet computer, a personal digital assistant (PDA), an AR/VR/XR device, a cellular telephone, a network appliance, a camera, a smartphone, an enhanced general packet radio service (EGPRS) mobile phone, a media player, a navigation device, an email device, a game console, or an appropriate combination of any two or more of these devices or other data processing devices.

Four computing devices 602, 604, 606 and 608 are depicted in FIG. 6 for simplicity. In the depicted example environment 600, the computing device 602 is depicted as a smartphone, the computing device 604 is depicted as a tablet-computing device, the computing device 606 is depicted as a desktop computing device, and the computing device 608 is depicted as an AR/VR/XR device. It is contemplated, however, that implementations of the present disclosure can be realized with any of the appropriate computing devices, such as those mentioned previously. Moreover, implementations of the present disclosure can employ any number of devices.

In some implementations, the back-end system 630 includes at least one server device 632 and optionally, at least one data store 634. In some implementations, the server device 632 is substantially similar to computing device 810 depicted below with reference to FIG. 8. In some implementations, the server device 632 is a server-class hardware type device. In some implementations, the back-end system 630 includes computer systems using clustered computers and components to function as a single pool of seamless resources when accessed through the communications network 610. For example, such implementations may be used in data center, cloud computing, storage area network (SAN), and network attached storage (NAS) applications. In some implementations, the back-end system 630 is deployed using a virtual machine(s).

In some implementations, the data store 634 is a repository for persistently storing and managing collections of data. Example data stores that may be employed within the described system include data repositories, such as a database as well as simpler store types, such as files, emails, and so forth. In some implementations, the data store 634 includes a database. In some implementations, a database is a series of bytes or an organized collection of data that is managed by a database management system (DBMS).

In some implementations, the back-end system 630 hosts one or more computer-implemented services provided by the described system with which users 622, 624, 626, and 626 can interact using the respective computing devices 602, 604, 606, and 608. For example, in some implementations, the back-end system 630 is configured to determine a personalized impulse response or a personalized transfer function according to implementations of the present disclosure.

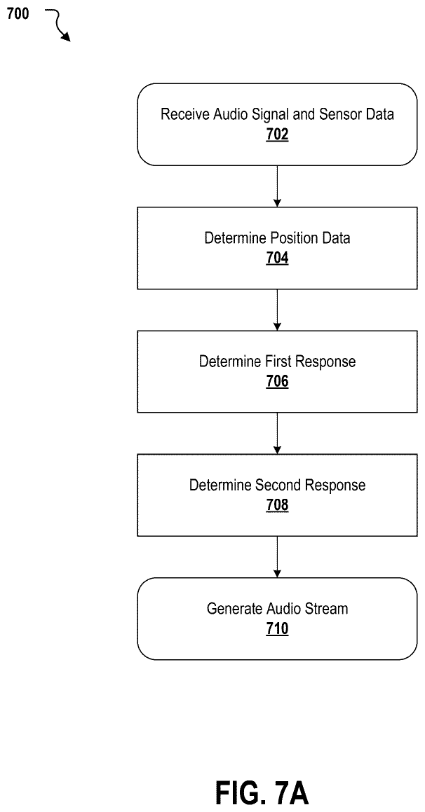

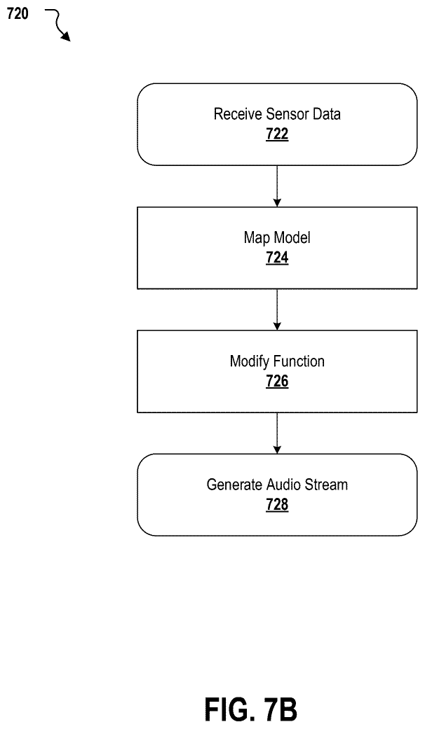

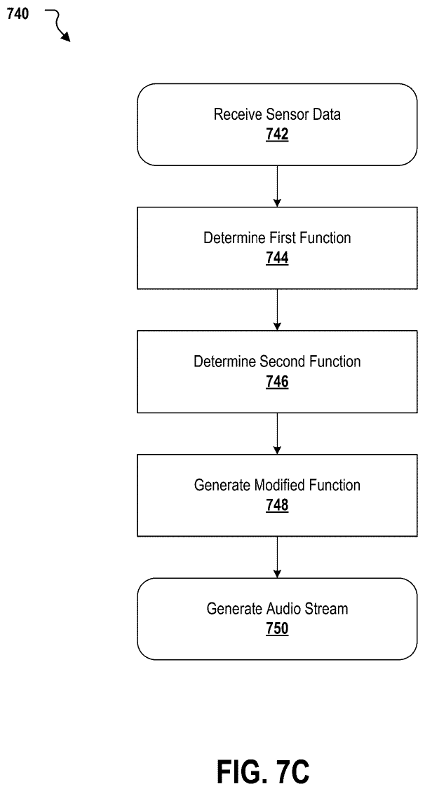

FIGS. 7A, 7B, and 7C each depict a flowchart of an example process 700, 720, and 740 respectively that can be implemented by implementations of the present disclosure. The example processes 700, 720, and 740 can be implemented by systems and components described with reference to FIGS. 1-6 and 8. The example process 700 generally shows in more detail how a personalized impulse response is determined or updated based on a recorded audio signal and sensor data (e.g., video and/or ICU data). The example process 720 generally shows in more detail how a personalized transfer function is determined or updated based on a sensor data (e.g., video and/or ICU data). The example process 740 generally shows in more detail a personalized transfer function is determined based on combining transfer functions in latent space according to assigned weighted values.

For clarity of presentation, the description that follows generally describes the example processes 700, 720, and 740 in the context of FIGS. 1-6 and 8. However, it will be understood that the processes 700, 720, and 740 may be performed, for example, by any other suitable system, environment, software, and hardware, or a combination of systems, environments, software, and hardware as appropriate. In some implementations, various operations of the processes 700, 720, and 740 can be run in parallel, in combination, in loops, or in any order.

For process 700 depicted in FIG. 7A, at 702, an audio signal and sensor data captured while a sound is broadcast from an audio source are received. In some implementations, the sensor data is captured by a camera and an inertial measurement unit sensor of a mobile device (e.g., the computing devices 602, 604, 606, or 608 depicted in FIG. 6). In some implementations, the mobile device comprises the audio source.

From 702, the process 700 proceeds to 704 where position data for the audio source is determined based on the sensor data. In some implementations, the position data for the audio source is determined with respect to a head of a user based on the sensor data. In some implementations, the position data includes a direction and a relative distance of the audio source with respect to a center of the head of the user, the center of the head of the user including a mid-point between ear openings of the user.

From 704, the process 700 proceeds to 706 where a first response is determined based on the audio signal and the position data. In some implementations, the first response characterizes a response of the audio signal as a function of time. In some implementations, the first response is determined by: determining a frame from the audio signal; determining a transform frame by applying a transform for the frame; determining an amplitude response for the transform frame; determining a phase filter from the amplitude response; and applying at least one position label, based on the position data, to the phase filter to form the first response. In some implementations, the phase filter is a minimum-phase filter.

In some implementations, the frame is a first frame. In some implementations, the first response is determined by: determining a second frame from the audio signal, where in the second frame includes data that overlaps data in the first frame. In some implementations, the transform is a fast Fourier transform. In some implementations, the audio signal is captured by a microphone. In some implementations, at least one position label is related to a direction and a distance of the audio source in relation to the microphone. In some implementations, before the frame is determined based on the audio signal, an amplitude response of the audio source in the audio signal and the microphone is compensated for.

From 706, the process 700 proceeds to 708 where a second response is determined by applying a filter to the first response. In some implementations, the filter includes an electronic filter that passes signals with a frequency higher than a cutoff threshold frequency and attenuates signals with frequencies lower than the cutoff threshold frequency. In some implementations, the filter is a first filter. In some implementations, a high-frequency component of the second response is determined by applying the first filter to the second response, and a low-frequency component of the second response is determined by applying a second filter to a selected impulse response.

In some implementations, the second response is associated with a user. In some implementations, a three-dimensional representation of a head is determined based on the sensor data, and the selected impulse response is selected from a dataset based on the three-dimensional representation and a selection criterion. In some implementations, the second filter includes an electronic filter that passes signals with a frequency lower than a cutoff threshold frequency and attenuates signals with frequencies higher than the cutoff threshold frequency. In some implementations, the second response is associated with an object. In some implementations, the second response is associated with only an object. In some implementations, the second response can be associated with an object and a user. In some implementations, the object can include a small object, a structure, a portion of a structure, multiple objects that function together as a single object, and/or so forth.

From 708, the process 700 proceeds to 710 where an audio stream is generated based on the second response. In some implementations, the second response is a personalized impulse response for the user. In some implementations, the characteristic (e.g., physical characteristic) includes the head of the user. In some implementations, the audio stream is configured for a characteristic of the user. In some implementations, the audio stream configured for the characteristic of the user is generated based on the personalized impulse response. For example, the generated audio stream may include music or other audio that is broadcast via an audio source (e.g., a loudspeaker connected to one of the computing devices 602, 604, 606, or 608 depicted in FIG. 6) to the user (e.g., the respective users 622, 624, 626, or 626 depicted in FIG. 6).

In some implementations, a transform is applied to the personalized impulse response to generate a personalized transfer function, and the audio stream configured for the characteristic of the user is generated based on the personalized transfer function. In some implementations, the transform is a Z-transform or a Laplace transform. In some implementations, at least one of the first response or the second response is a head-related impulse response. From 710, the process 700 ends or repeats.

For process 720 depicted in FIG. 7B, at 722, sensor data corresponding with a physical characteristic of a user is received. In some implementations, the sensor data is captured by an imaging sensor (e.g., a camera) of a mobile device (e.g., the device 110 described above with reference to FIG. 1 and/or the computing devices 602, 604, 606, or 608 described above with reference to FIG. 6). In some implementations, the physical characteristic of the user is related to the head of the user or at least one pinna of the user. In some implementations, the sensor data is produced by an imaging device coupled to a mobile device. In some implementations, the sensor data are images captured by the imaging device while the user moves the mobile device around the head or the at least one pinna of the user based on a prompt provided via a display associated with the mobile device.

From 722, the process 720 proceeds to 724 where a model is scaled to the physical characteristic. In some implementations, the model is scaled to the physical characteristic by determining a scaling factor by scaling the model to match the physical characteristic. In some implementations, a representation of the physical characteristic is generated based on the sensor data. In some implementations, the model is selected from a plurality of models based on the representation and a selection criterion. In some implementations, the representation is a 3D representation of the physical characteristic. In some implementations, the model is a head-and-torso model.

In some implementations, the selection criterion is tailored to match the shape of the physical characteristic more than a size of the physical characteristic. In some implementations, the model is selected by determining a volume of space between the representation of the physical characteristic and the plurality of models. In some implementations, the selection criterion includes selecting a model of the plurality of models having the smallest volume of space between the representation of the physical characteristic. In some implementations, the volume of space is determined using a plurality of optimization variables that include an origin, a rotation about the origin, and the scaling factor. In some implementations, the model is selected by determining the scaling factor.

From 724, the process 720 proceeds to 726 where a function representing an audio response is modified based on the scaled model to produce a modified function. In some implementations, the function is modified by modifying the function based on the scaling factor. In some implementations, the function is modified by warping the frequency of the function proportionally to the scaling factor. In some implementations, the function is a head related transfer function associated with the model. In some implementations, the modified function is a head related transfer function personalized for the user. In some implementations, the sensor data includes environment data corresponding to an environment around the user. In some implementations, the function is modified based on the environment data.

From 726, the process 720 proceeds to 728 where an audio stream is generated based on the modified function. In some implementations, the audio stream is provided to a user device or an audio output device such as headphones or a loudspeaker(s).

In some implementations, the physical characteristic is a first physical characteristic, the model is a first model, the function is a first function, the audio response is a first audio response, and the modified function is a modified first function. In some implementations, the sensor data corresponds with a second physical characteristic of a user.

In some implementations, a second model is scaled to the second physical characteristic. In some implementations, a second function (e.g., a transfer function) representing a second audio response is modified based on the scaled second model to produce a modified second function. In some implementations, the modified first function and the modified second function are combined to form a combined function (e.g., a combined transfer function). In some implementations, the audio stream is generated based on the combined function.

In some implementations, the modified first function and the modified second function are combined to form the combined function by determining a high-frequency component by applying a low-frequency filter to the modified first function, determining a low-frequency component by applying a high-frequency filter to the modified second function, and combining the low-frequency component and the high-frequency component to form the combined function.

In some implementations, the low-frequency filter includes an electronic filter that passes signals with a frequency lower than a cutoff threshold frequency and attenuates signals with frequencies higher than the cutoff threshold frequency. In some implementations, the high-frequency filter includes an electronic filter that passes signals with a frequency higher than a cutoff threshold frequency and attenuates signals with frequencies lower than the cutoff threshold frequency. In some implementations, the cutoff threshold frequency is set to about 3 kilohertz. From 728, the process 720 ends or repeats.

For process 740 depicted in FIG. 7C, at 742, sensor data corresponding with a physical characteristic of a user is received. In some implementations, the physical characteristic of the user is related to a head of the user or at least one pinna of the user. In some implementations, the sensor data is produced by an imaging device coupled to a mobile device and the sensor data are images captured by the imaging device while the user moves the mobile device around a head or at least one pinna of the user based on a prompt provided via a display associated with the mobile device.

From 742 the process 740 proceeds to 744 where a first function is determined based on a similarity between the physical characteristic of the user and a first model. In some implementations, the first function is determined based on a first weighted value and a first head related transfer function associated with the first model. In some implementations, the first weighted value is determined based on the similarity between the physical characteristic of the user and the first model.

From 744 the process 740 proceeds to 746 where a second function is determined based on a similarity of the physical characteristic between the user and a second model. In some implementations, the similarity between the physical characteristic of the user and the first model or the second model is determined based on a feature vector representing a geometry and a shape of the physical characteristic. In some implementations, the second function is determined based on a second weighted value and a second head related transfer function associated with the second model. In some implementations, the second weighted value is determined based on the similarity between the physical characteristic of the user and the second model.

In some implementations, the first model or the second model is a head-and-torso model, and the first function or the second function is a head related transfer function associated with the first model or the second model, respectively.

From 746 the process 740 proceeds to 748 where a modified function, representing an audio response, is generated by combining the first function and the second function. In some implementations, the modified function is a first modified function associated with a first query frequency of a range of frequencies. In some implementations, the modified function is an HRTF personalized for the user.

In some implementations, a second modified function associated with a second query frequency of the range of frequencies is generated. In some implementations, the first modified function and the second modified function are generated on a frequency grid comprising a plurality of directions. In some implementations, the first modified function and the second modified function form a head related transfer function spectra for the plurality of directions. In some implementations, an interaural time difference between a first direction of the plurality of directions and a second direction of the plurality of directions is determined. In some implementations, the interaural time difference is a binaural cue relating a lateral localization of an auditory event associated with the audio stream. In some implementations, the audio stream is generated based on a magnitude of the modified function and the interaural time difference. In some implementations, the audio stream is generated using a minimum-phase filter cascaded with a pure delay.

In some implementations, the modified function is generated by generating a combined latent space representation of the modified function by combining a first representation of a magnitude of the first model in latent space and a second representation of a magnitude of the second model in latent space. In some implementations, the first representation and the second representation are vectors. In some implementations, the modified function is generated by generating a magnitude vector for the user across a direction grid from the combined latent space representation. In some implementations, the combined latent space representation is generated using a trained artificial intelligence model.

In some implementations, the modified function is generated by combining the first function and the second function based on the first weighted value and the second weighted value, respectively. In some implementations, the first weighted value and the second weighted value are determined based on a distance between the feature vector associated with the user and the feature vector associated with the first model or the second model, respectively.

From 748 the process 740 proceeds to 750 where an audio stream is generated based on the modified function. From 750, the process 740 ends or repeats.

FIG. 8 depicts an example computing system 800 that includes a computer or computing device 810 that can be programmed or otherwise configured to implement systems or methods of the present disclosure. For example, the computing device 810 can be programmed or otherwise configured to implement the processes 700, 720, and/or 720. In some cases, the computing device 810 includes an operating system configured to perform executable instructions. The operating system is, for example, software, including programs and data that manages the device's hardware and provides services for execution of applications.

In the depicted implementation, the computer or computing device 810 includes an electronic processor (also “processor” and “computer processor” herein) 812, such as a central processing unit (CPU) or a graphics processing unit (GPU), which is optionally a single core, a multi core processor, or a plurality of processors for parallel processing. The depicted implementation also includes memory 817 (e.g., random-access memory, read-only memory, flash memory), storage unit 814 (e.g., hard disk or flash), communication interface module 815 (e.g., a network adapter or modem) for communicating with one or more other systems, and peripheral devices 816, such as cache, other memory, data storage, microphones, speakers, and the like. In some implementations, the memory 817, storage unit 814, communication interface module 815 and peripheral devices 816 are in communication with the electronic processor 812 through a communication bus (shown as solid lines), such as a motherboard. In some implementations, the bus of the computing device 810 includes multiple buses. The above-described hardware components of the computing device 810 can be used to facilitate, for example, an operating system and operations of one or more applications executed via the operating system. For example, a virtual representation of space may be provided via the user interface 825. In some implementations, the computing device 810 includes more or fewer components than those illustrated in FIG. 8 and performs functions other than those described herein.

In some implementations, the memory 817 and storage unit 814 include one or more physical apparatuses used to store data or programs on a temporary or permanent basis. In some implementations, the memory 817 is volatile memory and can use power to maintain stored information. In some implementations, the storage unit 814 is non-volatile memory and retains stored information when the computer is not powered. In further implementations, memory 817 or storage unit 814 is a combination of devices such as those disclosed herein. In some implementations, memory 817 or storage unit 814 is distributed across multiple machines such as a network-based memory or memory in multiple machines performing the operations of the computing device 810.

In some cases, the storage unit 814 is a data storage unit or data store for storing data. In some instances, the storage unit 814 stores files, such as drivers, libraries, and saved programs. In some implementations, the storage unit 814 stores data received by the device (e.g., audio data). In some implementations, the computing device 810 includes one or more additional data storage units that are external, such as located on a remote server that is in communication through a network (e.g., the communications network 610 described above with reference to FIG. 6).

In some implementations, platforms, systems, media, and methods as described herein are implemented by way of machine or computer executable code stored on an electronic storage location (e.g., non-transitory computer readable storage media) of the computing device 810, such as, for example, on the memory 817 or the storage unit 814. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 812 is configured to execute the code. In some implementations, the machine executable or machine-readable code is provided in the form of software. In some examples, during use, the code is executed by the electronic processor 812. In some cases, the code is retrieved from the storage unit 814 and stored on the memory 817 for ready access by the electronic processor 812. In some situations, the storage unit 814 is precluded, and machine-executable instructions are stored on the memory 817.

In some cases, the electronic processor 812 is a component of a circuit, such as an integrated circuit. One or more other components of the computing device 810 can be optionally included in the circuit. In some cases, the circuit is an application specific integrated circuit (ASIC) or a field programmable gate arrays (FPGAs). In some cases, the operations of the electronic processor 812 can be distributed across multiple machines (where individual machines can have one or more processors) that can be coupled directly or across a network.

In some cases, the computing device 810 is optionally operatively coupled to a communications network, such as the communications network 610 described above with reference to FIG. 6, via the communication interface module 815, which may include digital signal processing circuitry. Communication interface module 815 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 810 includes or is in communication with one or more output devices 820. In some cases, the output device 820 includes a display to send visual information to a user. In some cases, the output device 820 is a touch sensitive display that combines a display with a touch sensitive element that is operable to sense touch inputs as and functions as both the output device 820 and the input device 830. In still further cases, the output device 820 is a combination of devices such as those disclosed herein. In some cases, the output device 820 displays a user interface 825 generated by the computing device.

In some cases, the computing device 810 includes or is in communication with one or more input devices 830 that are configured to receive information from a user. In some cases, the input device 830 is a keyboard. In some cases, the input device 830 is a keypad (e.g., a telephone-based keypad). In some cases, the input device 830 is a cursor-control device including, by way of non-limiting examples, a mouse, trackball, trackpad, joystick, game controller, or stylus. In some cases, as described above, the input device 830 is a touchscreen or a multi-touchscreen. In other cases, the input device 830 is a microphone to capture voice or other sound input. In other cases, the Input device 830 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 812. As such, it should be noted that a plurality of hardware and software-based devices, as well as a plurality of different structural components may be employed to implement various implementations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

### Examples

The following paragraphs provide various examples of the implementations disclosed herein.

Example 1 is a method that includes receiving an audio signal and sensor data captured while a sound is broadcast from an audio source; determining position data for the audio source based on the sensor data; determining a first response based on the audio signal and the position data, the first response characterizing a response of the audio signal as a function of time; determining a second response by applying a filter to the first response; and generating an audio stream based on the second response.

Example 2 includes the subject matter of Example 1, and further includes determining the first response by: determining a frame from the audio signal and determining a transform frame by applying a transform for the frame.

Example 3 includes the subject matter of Example 1 or 2, and further includes determining the first response by: determining an amplitude response for the transform frame and determining a phase filter from the amplitude response.

Example 4 includes the subject matter of any of Examples 1-3, and further includes determining the first response by applying at least one position label, based on the position data, to the phase filter to form the first response.

Example 5 includes the subject matter of any of Examples 1-4, and further specifies that the phase filter is a minimum-phase filter.

Example 6 includes the subject matter of any of Examples 1-5, and further specifies that the frame is a first frame, and that the method further includes determining the first response by determining a second frame from the audio signal.

Example 7 includes the subject matter of any of Examples 1-6, and further specifies that the second frame includes data that overlaps data in the first frame.

Example 8 includes the subject matter of any of Examples 1-7, and further specifies that the transform is a fast Fourier transform.

Example 9 includes the subject matter of any of Examples 1-8, and further specifies that the audio signal is captured by a microphone.

Example 10 includes the subject matter of any of Examples 1-9, and further specifies that at least one position label is related to a direction and a distance of the audio source in relation to the microphone.

Example 11 includes the subject matter of any of Examples 1-10, and further includes before determining the frame based on the audio signal, compensating for an amplitude response of the audio source in the audio signal and the microphone.

Example 12 includes the subject matter of any of Examples 1-11, and further specifies that the filter includes an electronic filter that passes signals with a frequency higher than a cutoff threshold frequency and attenuates signals with frequencies lower than the cutoff threshold frequency.

Example 13 includes the subject matter of any of Examples 1-12, and further specifies that the filter is a first filter; and that the method further includes determining a high-frequency component of the second response by applying the first filter to the second response and determining a low-frequency component of the second response by applying a second filter to a selected impulse response.

Example 14 includes the subject matter of any of Examples 1-13, and further specifies that the second response is associated with a user.

Example 15 includes the subject matter of any of Examples 1-14, and further specifies that the audio stream is configured for a characteristic of the user.

Example 16 includes the subject matter of any of Examples 1-15, and further includes determining a three-dimensional representation of a head based on the sensor data and selecting the selected impulse response from a dataset based on the three-dimensional representation and a selection criterion.

Example 17 includes the subject matter of any of Examples 1-16, and further specifies that the second filter includes an electronic filter that passes signals with a frequency lower than a cutoff threshold frequency and attenuates signals with frequencies higher than the cutoff threshold frequency.

Example 18 includes the subject matter of any of Examples 1-17, and further includes determining the position data for the audio source with respect to a head of a user based on the sensor data.

Example 19 includes the subject matter of any of Examples 1-18, and further specifies that the position data includes a direction and a relative distance of the audio source with respect to a center of the head of the user, the center of the head of the user including a mid-point between ear openings of the user.

Example 20 includes the subject matter of any of Examples 1-19, and further specifies that the second response is a personalized impulse response for the user and the characteristic includes the head of the user.

Example 21 includes the subject matter of any of Examples 1-20, and further includes generating the audio stream configured for the characteristic of the user based on the personalized impulse response.

Example 22 includes the subject matter of any of Examples 1-21, and further includes applying a transform to the personalized impulse response to generate a personalized transfer function and generating the audio stream configured for the characteristic of the user based on the personalized transfer function.

Example 23 includes the subject matter of any of Examples 1-22, and further specifies that the transform is a Z-transform or a Laplace transform.

Example 24 includes the subject matter of any of Examples 1-23, and further specifies that at least one of the first response or the second response is a head-related impulse response.

Example 25 includes the subject matter of any of Examples 1-24, and further specifies that the sensor data is captured by a camera or an inertial measurement unit sensor of a mobile device that includes the audio source.

Example 26 includes the subject matter of any of Examples 1-25, and further specifies that the second response is associated with an object.

Example 27 includes a computer-readable medium storing instructions that when executed by an electronic processor cause the electronic processor to perform the method as described in any of the Examples 1-26.

Example 28 is a system that includes a computing device and an electronic processor coupled to the computing device. The computer includes an electroacoustic transducer configured to broadcast a sound, an imaging sensor, and an audio sensor. The electronic processor is configured to receive an audio signal from the audio sensor; receive sensor data from the imaging sensor, the audio signal and the sensor data captured while the electroacoustic transducer broadcast the sound; determine position data for the electroacoustic transducer based on the sensor data; determine a first response based on the audio signal and the position data, the first response characterizing a response of the audio signal as a function of time; determine a second response associated with a user by applying a filter to the first response; and generate an audio stream configured for a characteristic of the user based on the second response.

Example 29 includes the subject matter of Example 28 further specifies that the electronic processor is configured to determine the first response by: determining a frame from the audio signal and determining a transform frame by applying a transform for the frame.

Example 30 includes the subject matter of Example 28 or 29, and further specifies that the electronic processor is configured to determine the first response by: determining an amplitude response for the transform frame and determining a phase filter from the amplitude response.

Example 31 includes the subject matter of any of Examples 28-30, and further specifies that the electronic processor is configured to determine the first response by applying at least one position label, based on the position data, to the phase filter to form the first response.

Example 32 includes the subject matter of any of Examples 28-31, and further specifies that the phase filter is a minimum-phase filter.

Example 33 includes the subject matter of any of Examples 28-32, and further specifies that the frame is a first frame, and that the electronic processor is further configured to determine the first response by determining a second frame from the audio signal.

Example 34 includes the subject matter of any of Examples 28-33, and further specifies that the second frame includes data that overlaps data in the first frame.

Example 35 includes the subject matter of any of Examples 28-34, and further specifies that the transform is a fast Fourier transform.

Example 36 includes the subject matter of any of Examples 28-35, and further specifies that the audio signal is captured by a microphone.

Example 37 includes the subject matter of any of Examples 28-36, and further specifies that at least one position label is related to a direction and a distance of the audio source in relation to the microphone.

Example 38 includes the subject matter of any of Examples 28-37, and further specifies that the electronic processor is further configured to, before determining the frame based on the audio signal, compensate for an amplitude response of the audio source in the audio signal and the microphone.

Example 39 includes the subject matter of any of Examples 28-38, and further specifies that the filter includes an electronic filter that passes signals with a frequency higher than a cutoff threshold frequency and attenuates signals with frequencies lower than the cutoff threshold frequency.

Example 40 includes the subject matter of any of Examples 28-39, and further specifies that the filter is a first filter; and that the electronic processor is further configured to determine a high-frequency component of the second response by applying the first filter to the second response and determine a low-frequency component of the second response by applying a second filter to a selected impulse response.

Example 41 includes the subject matter of any of Examples 28-40, and further specifies that the second response is associated with a user.

Example 42 includes the subject matter of any of Examples 28-41, and further specifies that the audio stream is configured for a characteristic of the user.

Example 43 includes the subject matter of any of Examples 28-42, and further specifies that the electronic processor is further configured to determine a three-dimensional representation of a head based on the sensor data and select the selected impulse response from a dataset based on the three-dimensional representation and a selection criterion.

Example 44 includes the subject matter of any of Examples 28-43, and further specifies that the second filter includes an electronic filter that passes signals with a frequency lower than a cutoff threshold frequency and attenuates signals with frequencies higher than the cutoff threshold frequency.

Example 45 includes the subject matter of any of Examples 28-44, and further specifies that the electronic processor is further configured to determine the position data for the audio source with respect to a head of a user based on the sensor data.

Example 46 includes the subject matter of any of Examples 28-45, and further specifies that the position data includes a direction and a relative distance of the audio source with respect to a center of the head of the user, the center of the head of the user including a mid-point between ear openings of the user.

Example 47 includes the subject matter of any of Examples 28-46, and further specifies that the second response is a personalized impulse response for the user and the characteristic includes the head of the user.

Example 48 includes the subject matter of any of Examples 28-47, and further specifies that the electronic processor is further configured to generate the audio stream configured for the characteristic of the user based on the personalized impulse response.

Example 49 includes the subject matter of any of Examples 28-48, and further specifies that the electronic processor is further configured to apply a transform to the personalized impulse response to generate a personalized transfer function and generate the audio stream configured for the characteristic of the user based on the personalized transfer function.

Example 50 includes the subject matter of any of Examples 28-49, and further specifies that the transform is a Z-transform or a Laplace transform.

Example 51 includes the subject matter of any of Examples 28-50, and further specifies that at least one of the first response or the second response is a head-related impulse response.

Example 52 includes the subject matter of any of Examples 28-51, and further specifies that the sensor data is captured by a camera or an inertial measurement unit sensor of a mobile device that includes the audio source.

Example 53 includes the subject matter of any of Examples 27-52, and further specifies that the second response is associated with an object.

Example 54 is a method that includes receiving sensor data corresponding with a physical characteristic of a user; scaling a model to the physical characteristic; modifying a function, representing an audio response, based on the scaled model to produce a modified function; and generating an audio stream based on the modified function.

Example 55 includes the subject matter of Example 54, and further specifies that scaling the model to the physical characteristic includes determining a scaling factor by scaling the model to match the physical characteristic.

Example 56 includes the subject matter of Example 54 or 55, and further specifies that modifying the function includes modifying the function based on the scaling factor.

Example 57 includes the subject matter of any of Examples 54-56, and further specifies that modifying the function includes warping a frequency of the function proportionally to the scaling factor.

Example 58 includes the subject matter of any of Examples 54-57, and further includes providing the audio stream to a user device or an output audio device such as a loudspeaker or headphones.

Example 59 includes the subject matter of any of Examples 54-58, and further includes generating, based on the sensor data, a representation of the physical characteristic.

Example 60 includes the subject matter of any of Examples 54-59, and further includes selecting the model from a plurality of models based on the representation and a selection criterion.

Example 61 includes the subject matter of any of Examples 54-60, and further specifies that the representation is a 3D representation of the physical characteristic.

Example 62 includes the subject matter of any of Examples 54-61, and further specifies that the selection criterion is tailored to match a shape of the physical characteristic more than a size of the physical characteristic.

Example 63 includes the subject matter of any of Examples 54-62, and further specifies that selecting the model includes determining a volume of space between the representation of the physical characteristic and the plurality of models.

Example 64 includes the subject matter of any of Examples 54-63, and further specifies that the selection criterion includes selecting a model of the plurality of models having a smallest volume of space between the representation of the physical characteristic.

Example 65 includes the subject matter of any of Examples 54-64, and further specifies that the volume of space is determined using a plurality of optimization variables that include an origin, a rotation about the origin, and the scaling factor.

Example 66 includes the subject matter of any of Examples 54-65, and further specifies that selecting the model includes determining the scaling factor.

Example 67 includes the subject matter of any of Examples 54-66, and further specifies that the physical characteristic is a first physical characteristic, the model is a first model, the function is a first function, the audio response is a first audio response, and the modified function is a modified first function.

Example 68 includes the subject matter of any of Examples 54-67, and further specifies that the sensor data corresponds with a second physical characteristic of a user.

Example 69 includes the subject matter of any of Examples 54-68, and further includes scaling a second model to the second physical characteristic.

Example 70 includes the subject matter of any of Examples 54-69, and further includes modifying a second function, representing a second audio response, based on the scaled second model to produce a modified second function.

Example 71 includes the subject matter of any of Examples 54-70, and further includes combining the modified first function and the modified second function to form a combined function.

Example 72 includes the subject matter of any of Examples 54-71, and further specifies that generating the audio stream based on the modified function includes generating the audio stream based on the combined function.

Example 73 includes the subject matter of any of Examples 54-72, and further specifies that combining the modified first function and the modified second function to form the combined function includes determining a high-frequency component by applying a low-frequency filter to the modified first function.

Example 74 includes the subject matter of any of Examples 54-73, and further specifies that combining the modified first function and the modified second function to form the combined function includes determining a low-frequency component by applying a high-frequency filter to the modified second function.

Example 75 includes the subject matter of any of Examples 54-74, and further specifies that combining the modified first function and the modified second function to form the combined function includes combining the low-frequency component and the high-frequency component to form the combined function.

Example 76 includes the subject matter of any of Examples 54-75, and further specifies that the low-frequency filter includes an electronic filter that passes signals with a frequency lower than a cutoff threshold frequency and attenuates signals with frequencies higher than the cutoff threshold frequency.

Example 77 includes the subject matter of any of Examples 54-76, and further specifies that the high-frequency filter includes an electronic filter that passes signals with a frequency higher than a cutoff threshold frequency and attenuates signals with frequencies lower than the cutoff threshold frequency.

Example 78 includes the subject matter of any of Examples 54-77, and further specifies that the cutoff threshold frequency is set to about 3 kilohertz.

Example 79 includes the subject matter of any of Examples 54-78, and further specifies that the physical characteristic of the user is related to a head of the user or at least one pinna of the user.

Example 80 includes the subject matter of any of Examples 54-79, and further specifies that the sensor data is produced by an imaging device coupled to a mobile device.

Example 81 includes the subject matter of any of Examples 54-80, and further specifies that the sensor data are images captured by the imaging device while the user moves the mobile device around the head or the at least one pinna of the user based on a prompt provided via a display associated with the mobile device.

Example 82 includes the subject matter of any of Examples 54-81, and further specifies that the model is a head-and-torso model.

Example 83 includes the subject matter of any of Examples 54-82, and further specifies that the function is a head related transfer function associated with the model.

Example 84 includes the subject matter of any of Examples 54-83, and further specifies that the modified function is a head related transfer function personalized for the user.

Example 85 includes a computer-readable medium storing instructions that when executed by an electronic processor cause the electronic processor to perform the method as described in any of the Examples 54-84.

Example 86 is a system that includes a computing device and an electronic processor coupled to the computing device. The computing device includes an imaging sensor. The electronic processor is configured to: receive, from the imaging sensor, sensor data corresponding with a physical characteristic of a user; scale a model to the physical characteristic; modify a function, representing an audio response, based on the scaled model to produce a modified function; and provide an audio stream based on the modified function.

Example 87 includes the subject matter of Example 86, and further specifies the model is scaled to the physical characteristic by determining a scaling factor by scaling the model to match the physical characteristic.

Example 88 includes the subject matter of Example 86 or 87, and further specifies that the function is modified by modifying the function based on the scaling factor.

Example 89 includes the subject matter of any of Examples 86-88, and further specifies that the function is modified by warping a frequency of the function proportionally to the scaling factor.

Example 90 includes the subject matter of any of Examples 86-89, and further specifies that the electronic processor is configured to provide the audio stream to the user device or an output audio device such as a loudspeaker or headphones.

Example 91 includes the subject matter of any of Examples 86-90, and further specifies that the electronic processor is configured to generate, based on the sensor data, a representation of the physical characteristic.

Example 92 includes the subject matter of any of Examples 86-91, and further specifies that the electronic processor is configured to select the model from a plurality of models based on the representation and a selection criterion.

Example 93 includes the subject matter of any of Examples 86-92, and further specifies that the representation is a 3D representation of the physical characteristic.

Example 94 includes the subject matter of any of Examples 86-93, and further specifies that the selection criterion is tailored to match a shape of the physical characteristic more than a size of the physical characteristic.

Example 95 includes the subject matter of any of Examples 86-94, and further specifies that the electronic processor is configured to select the model by determining a volume of space between the representation of the physical characteristic and the plurality of models.

Example 96 includes the subject matter of any of Examples 86-95, and further specifies that the selection criterion includes selecting a model of the plurality of models having a smallest volume of space between the representation of the physical characteristic.

Example 97 includes the subject matter of any of Examples 86-96, and further specifies that the volume of space is determined using a plurality of optimization variables that include an origin, a rotation about the origin, and the scaling factor.

Example 98 includes the subject matter of any of Examples 86-97, and further specifies that the electronic processor is configured to select the model by determining the scaling factor.

Example 99 includes the subject matter of any of Examples 86-98, and further specifies that the physical characteristic is a first physical characteristic, the model is a first model, the function is a first function, the audio response is a first audio response, and the modified function is a modified first function.

Example 100 includes the subject matter of any of Examples 86-99 and further specifies that the sensor data corresponds with a second physical characteristic of a user.

Example 101 includes the subject matter of any of Examples 86-100, and further specifies that the electronic processor is configured to scale a second model to the second physical characteristic.

Example 102 includes the subject matter of any of Examples 86-101, and further specifies that the electronic processor is configured to modify a second function, representing a second audio response, based on the scaled second model to produce a modified second function.

Example 103 includes the subject matter of any of Examples 86-102, and further specifies that the electronic processor is configured to combine the modified first function and the modified second function to form a combined function.

Example 104 includes the subject matter of any of Examples 86-103, and further specifies that the audio stream is generated based on the combined function.

Example 105 includes the subject matter of any of Examples 86-104, and further specifies that the electronic processor is configured to combine the modified first function and the modified second function to form the combined function by determining a high-frequency component by applying a low-frequency filter to the modified first function.

Example 106 includes the subject matter of any of Examples 86-105, and further specifies that the electronic processor is configured to combine the modified first function and the modified second function to form the combined function by determining a low-frequency component by applying a high-frequency filter to the modified second function.

Example 107 includes the subject matter of any of Examples 86-106, and further specifies that the electronic processor is configured to combine the modified first function and the modified second function to form the combined function by combining the low-frequency component and the high-frequency component to form the combined function.

Example 108 includes the subject matter of any of Examples 86-107, and further specifies that the low-frequency filter includes an electronic filter that passes signals with a frequency lower than a cutoff threshold frequency and attenuates signals with frequencies higher than the cutoff threshold frequency.

Example 109 includes the subject matter of any of Examples 86-108, and further specifies that the high-frequency filter includes an electronic filter that passes signals with a frequency higher than a cutoff threshold frequency and attenuates signals with frequencies lower than the cutoff threshold frequency.

Example 110 includes the subject matter of any of Examples 86-109, and further specifies that the cutoff threshold frequency is set to about 3 kilohertz.

Example 111 includes the subject matter of any of Examples 86-110, and further specifies that the physical characteristic of the user is related to a head of the user or at least one pinna of the user.

Example 112 includes the subject matter of any of Examples 86-111, and further specifies that the sensor data are images captured by the imaging sensor while the user moves the computing device around the head or the at least one pinna of the user based on prompt provided via a display associated with the computing device.

Example 113 includes the subject matter of any of Examples 86-112, and further specifies that the model is a head-and-torso model.

Example 114 includes the subject matter of any of Examples 86-113, and further specifies that the function is a head related transfer function associated with the model.

Example 115 includes the subject matter of any of Examples 86-114, and further specifies that the modified function is a head related transfer function personalized for the user.

Example 116 is a method that includes modifying a function representing an audio response using a model scaled to a physical characteristic of a user based on sensor data corresponding with the physical characteristic and generating an audio stream based on the modified function.

Example 117 includes the subject matter of Example 116, and further specifies that scaling the model to the physical characteristic includes determining a scaling factor by scaling the model to match the physical characteristic.

Example 118 includes the subject matter of Example 116 or 117, and further specifies that modifying the function includes modifying the function based on the scaling factor.

Example 119 includes the subject matter of any of Examples 116-118, and further specifies that modifying the function includes warping a frequency of the function proportionally to the scaling factor.

Example 120 includes the subject matter of any of Examples 116-119, and further includes providing the audio stream to a user device or an output audio device such as a loudspeaker or headphones.

Example 121 includes the subject matter of any of Examples 116-120, and further includes generating, based on the sensor data, a representation of the physical characteristic.

Example 122 includes the subject matter of any of Examples 116-121, and further includes selecting the model from a plurality of models based on the representation and a selection criterion.

Example 123 includes the subject matter of any of Examples 116-122, and further specifies that the representation is a 3D representation of the physical characteristic.

Example 124 includes the subject matter of any of Examples 116-123, and further specifies that the selection criterion is tailored to match a shape of the physical characteristic more than a size of the physical characteristic.

Example 125 includes the subject matter of any of Examples 116-124, and further specifies that selecting the model includes determining a volume of space between the representation of the physical characteristic and the plurality of models.

Example 126 includes the subject matter of any of Examples 116-125, and further specifies that the selection criterion includes selecting a model of the plurality of models having a smallest volume of space between the representation of the physical characteristic.

Example 127 includes the subject matter of any of Examples 116-126, and further specifies that the volume of space is determined using a plurality of optimization variables that include an origin, a rotation about the origin, and the scaling factor.

Example 128 includes the subject matter of any of Examples 116-127, and further specifies that selecting the model includes determining the scaling factor.

Example 129 includes the subject matter of any of Examples 116-128, and further specifies that the physical characteristic is a first physical characteristic, the model is a first model, the function is a first function, the audio response is a first audio response, and the modified function is a modified first function.

Example 130 includes the subject matter of any of Examples 116-129, and further specifies that the sensor data corresponds with a second physical characteristic of a user.

Example 131 includes the subject matter of any of Examples 116-130, and further includes scaling a second model to the second physical characteristic.

Example 132 includes the subject matter of any of Examples 116-131, and further includes modifying a second function, representing a second audio response, based on the scaled second model to produce a modified second function.

Example 133 includes the subject matter of any of Examples 116-132, and further includes combining the modified first function and the modified second function to form a combined function.

Example 134 includes the subject matter of any of Examples 116-133, and further specifies that generating the audio stream based on the modified function includes generating the audio stream based on the combined function.

Example 135 includes the subject matter of any of Examples 116-134, and further specifies that combining the modified first function and the modified second function to form the combined function includes determining a high-frequency component by applying a low-frequency filter to the modified first function.

Example 136 includes the subject matter of any of Examples 116-135, and further specifies that combining the modified first function and the modified second function to form the combined function includes determining a low-frequency component by applying a high-frequency filter to the modified second function.

Example 137 includes the subject matter of any of Examples 116-136, and further specifies that combining the modified first function and the modified second function to form the combined function includes combining the low-frequency component and the high-frequency component to form the combined function.

Example 138 includes the subject matter of any of Examples 116-137, and further specifies that the low-frequency filter includes an electronic filter that passes signals with a frequency lower than a cutoff threshold frequency and attenuates signals with frequencies higher than the cutoff threshold frequency.

Example 139 includes the subject matter of any of Examples 116-138, and further specifies that the high-frequency filter includes an electronic filter that passes signals with a frequency higher than a cutoff threshold frequency and attenuates signals with frequencies lower than the cutoff threshold frequency.

Example 149 includes the subject matter of any of Examples 116-139, and further specifies that the cutoff threshold frequency is set to about 3 kilohertz.

Example 141 includes the subject matter of any of Examples 116-140, and further specifies that the physical characteristic of the user is related to a head of the user or at least one pinna of the user.

Example 142 includes the subject matter of any of Examples 116-141, and further specifies that the sensor data is produced by an imaging device coupled to a mobile device.

Example 143 includes the subject matter of any of Examples 116-142, and further specifies that the sensor data are images captured by the imaging device while the user moves the mobile device around the head or the at least one pinna of the user based on a prompt provided via a display associated with the mobile device.

Example 144 includes the subject matter of any of Examples 116-143, and further specifies that the model is a head-and-torso model.

Example 145 includes the subject matter of any of Examples 116-144, and further specifies that the function is a head related transfer function associated with the model.

Example 146 includes the subject matter of any of Examples 116-145, and further specifies that the modified function is a head related transfer function personalized for the user.

Example 147 includes the subject matter of any of Examples 116-146, and further specifies that the sensor data includes environment data corresponding to an environment around the user.

Example 148 includes the subject matter of any of Examples 116-147, and further includes modifying the function based on the environment data.

Example 149 includes a computer-readable medium storing instructions that when executed by an electronic processor cause the electronic processor to perform the method as described in any of Examples 116-148.

Example 150 is a method that includes receiving sensor data corresponding with a physical characteristic of a user; determining a first function based on a similarity between the physical characteristic of the user and a first model; determining a second function based on a similarity of the physical characteristic between the user and a second model; generating a modified function, representing an audio response, by combining the first function and the second function; and generating an audio stream based on the modified function.

Example 151 includes the subject matter of Example 150, and further specifies that the modified function is a first modified function associated with a first query frequency of a range of frequencies.

Example 152 includes the subject matter of Example 150 or 151, and further includes generating a second modified function associated with a second query frequency of the range of frequencies.

Example 153 includes the subject matter of any of Examples 150-152, and further specifies that the first modified function and the second modified function are generated on a frequency grid comprising a plurality of directions.

Example 154 includes the subject matter of any of Examples 150-153, and further specifies that the first modified function and the second modified function forming a head related transfer function spectra for the plurality of directions.

Example 155 includes the subject matter of any of Examples 150-154, and further includes determining an interaural time difference between a first direction of the plurality of directions and a second direction of the plurality of directions.

Example 156 includes the subject matter of any of Examples 150-155, and further specifies that the interaural time difference is a binaural cue relating a lateral localization of an auditory event associated with the audio stream.

Example 157 includes the subject matter of any of Examples 150-156, and further includes generating the audio stream based on a magnitude of the modified function and the interaural time difference.

Example 158 includes the subject matter of any of Examples 150-157, and further includes generating the audio stream using a minimum-phase filter cascaded with a pure delay.

Example 159 includes the subject matter of any of Examples 150-158, and further includes generating the modified function by: generating a combined latent space representation of the modified function by combining a first representation of a magnitude of the first model in latent space and a second representation of a magnitude of the second model in latent space.

Example 160 includes the subject matter of any of Examples 150-159, and further specifies that the first representation and the second representation are vectors.

Example 161 includes the subject matter of any of Examples 150-160, and further includes generating the modified function by: generating a magnitude vector for the user across a direction grid from the combined latent space representation.

Example 162 includes the subject matter of any of Examples 150-152, and further specifies that the combined latent space representation is generated using a trained artificial intelligence model.

Example 163 includes the subject matter of any of Examples 150-162, and further specifies that the similarity between the physical characteristic of the user and the first model or the second model is determined based on a feature vector representing a geometry and a shape of the physical characteristic.

Example 164 includes the subject matter of any of Examples 150-163, and further includes determining the first function based on a first weighted value and a first head related transfer function associated with the first model, the first weighted value based on the similarity between the physical characteristic of the user and the first model; determining the second function based on a second weighted value and a second head related transfer function associated with the second model, the second weighted value based on the similarity between the physical characteristic of the user and the second model; and generating the modified function by combining the first function and the second function based on the first weighted value and the second weighted value respectively.

Example 165 includes the subject matter of any of Examples 150-164, and further specifies that the first weighted value and the second weighted value are determined based on a distance between the feature vector associated with the user and the feature vector associated with the first model or the second model, respectively.

Example 166 includes the subject matter of any of Examples 150-165, and further specifies that the physical characteristic of the user is related to a head of the user or at least one pinna of the user.

Example 167 includes the subject matter of any of Examples 150-166, and further specifies that the sensor data is produced by an imaging device coupled to a mobile device and the sensor data are images captured by the imaging device while the user moves the mobile device around a head or at least one pinna of the user based on a prompt provided via a display associated with the mobile device.

Example 168 includes the subject matter of any of Examples 150-167, and further specifies that the first model or the second model is a head-and-torso model, and the first function or the second function is a head related transfer function associated with the first model or the second model, respectively.

Example 169 includes the subject matter of any of Examples 150-168, and further specifies that the modified function is a head related transfer function personalized for the user.

Example 170 includes a computer-readable medium storing instructions that when executed by an electronic processor cause the electronic processor to perform the method as described in any of Examples 150-169.

Example 171 is a system that includes a computing device including an imaging sensor, and an electronic processor coupled to the computing device. The electronic processor is configured to receive, from the imaging sensor, sensor data corresponding with a physical characteristic of a user; determine a first function associated based on a similarity between the physical characteristic of the user and a first model; determine a second function based on a similarity of the physical characteristic between the user and a second model; generate a modified function, representing an audio response, by combining the first function and the second function; and generate an audio stream based on the modified function.

Example 172 includes the subject matter of Example 171, and further specifies that the modified function is a first modified function associated with a first query frequency of a range of frequencies.

Example 173 includes the subject matter of Example 171 or 172, and further includes generating a second modified function associated with a second query frequency of the range of frequencies.

Example 174 includes the subject matter of any of Examples 171-173, and further specifies that the first modified function and the second modified function are generated on a frequency grid comprising a plurality of directions.

Example 175 includes the subject matter of any of Examples 171-174, and further specifies that the first modified function and the second modified function forming a head related transfer function spectra for the plurality of directions.

Example 176 includes the subject matter of any of Examples 171-175, and further includes determining an interaural time difference between a first direction of the plurality of directions and a second direction of the plurality of directions.

Example 177 includes the subject matter of any of Examples 171-176, and further specifies that the interaural time difference is a binaural cue relating a lateral localization of an auditory event associated with the audio stream.

Example 178 includes the subject matter of any of Examples 171-177, and further includes generating the audio stream based on a magnitude of the modified function and the interaural time difference.

Example 179 includes the subject matter of any of Examples 171-178, and further includes generating the audio stream using a minimum-phase filter cascaded with a pure delay.

Example 180 includes the subject matter of any of Examples 171-179, and further includes generating the modified function by: generating a combined latent space representation of the modified function by combining a first representation of a magnitude of the first model in latent space and a second representation of a magnitude of the second model in latent space.

Example 181 includes the subject matter of any of Examples 171-180, and further specifies that the first representation and the second representation are vectors.

Example 182 includes the subject matter of any of Examples 171-181, and further includes generating the modified function by: generating a magnitude vector for the user across a direction grid from the combined latent space representation.

Example 183 includes the subject matter of any of Examples 171-182, and further specifies that the combined latent space representation is generated using a trained artificial intelligence model.

Example 184 includes the subject matter of any of Examples 171-183, and further specifies that the similarity between the physical characteristic of the user and the first model or the second model is determined based on a feature vector representing a geometry and a shape of the physical characteristic.

Example 185 includes the subject matter of any of Examples 171-184, and further includes determining the first function based on a first weighted value and a first head related transfer function associated with the first model, the first weighted value based on the similarity between the physical characteristic of the user and the first model; determining the second function based on a second weighted value and a second head related transfer function associated with the second model, the second weighted value based on the similarity between the physical characteristic of the user and the second model; and generating the modified function by combining the first function and the second function based on the first weighted value and the second weighted value respectively.

Example 186 includes the subject matter of any of Examples 171-185, and further specifies that the first weighted value and the second weighted value are determined based on a distance between the feature vector associated with the user and the feature vector associated with the first model or the second model, respectively.

Example 187 includes the subject matter of any of Examples 171-186, and further specifies that the physical characteristic of the user is related to a head of the user or at least one pinna of the user.

Example 188 includes the subject matter of any of Examples 171-187, and further specifies that the sensor data is produced by an imaging device coupled to a mobile device and the sensor data are images captured by the imaging device while the user moves the mobile device around a head or at least one pinna of the user based on a prompt provided via a display associated with the mobile device.

Example 189 includes the subject matter of any of Examples 171-188, and further specifies that the first model or the second model is a head-and-torso model, and the first function or the second function is a head related transfer function associated with the first model or the second model, respectively.

Example 190 includes the subject matter of any of Examples 171-189, and further specifies that the modified function is a head related transfer function personalized for the user.

Example 191 includes the subject matter of any of Examples 171-190, and further specifies that the electronic processor is further configured to provide the audio stream to the computing device.

What is claimed is:

1. A method comprising:
receiving sensor data corresponding with a physical characteristic of a user;
determining a first function based on a similarity between the physical characteristic of the user and a first model;
determining a second function based on a similarity of the physical characteristic between the user and a second model;
generating a modified function, representing an audio response, by combining the first function and the second function; and
generating an audio stream based on the modified function.

2. The method of claim 1, wherein the modified function is a first modified function associated with a first query frequency of a range of frequencies.

3. The method of claim 2, further comprising:
generating a second modified function associated with a second query frequency of the range of frequencies.

4. The method of claim 3, wherein the first modified function and the second modified function are generated on a frequency grid comprising a plurality of directions, the first modified function and the second modified function forming a head related transfer function spectra for the plurality of directions.

5. The method of claim 4, further comprising:
determining an interaural time difference between a first direction of the plurality of directions and a second direction of the plurality of directions.

6. The method of claim 5, wherein the interaural time difference is a binaural cue relating a lateral localization of an auditory event associated with the audio stream.

7. The method of claim 5, further comprising:
generating the audio stream based on a magnitude of the modified function and the interaural time difference.

8. The method of claim 7, further comprising:
generating the audio stream using a minimum-phase filter cascaded with a pure delay.

9. The method of claim 1, further comprising generating the modified function by:
generating a combined latent space representation of the modified function by combining a first representation of a magnitude of the first model in latent space and a second representation of a magnitude of the second model in latent space.

10. The method of claim 9, wherein the first representation and the second representation are vectors.

11. The method of claim 9, further comprising generating the modified function by:
generating a magnitude vector for the user across a direction grid from the combined latent space representation.

12. The method of claim 11, wherein the combined latent space representation is generated using a trained artificial intelligence model.

13. The method of claim 1, wherein the similarity between the physical characteristic of the user and the first model or the second model is determined based on a feature vector representing a geometry and a shape of the physical characteristic.

14. The method of claim 13, further comprising:
determining the first function based on a first weighted value and a first head related transfer function associated with the first model, the first weighted value based on the similarity between the physical characteristic of the user and the first model;
determining the second function based on a second weighted value and a second head related transfer function associated with the second model, the second weighted value based on the similarity between the physical characteristic of the user and the second model; and
generating the modified function by combining the first function and the second function based on the first weighted value and the second weighted value respectively.

15. The method of claim 14, wherein the first weighted value and the second weighted value are determined based on a distance between the feature vector associated with the user and the feature vector associated with the first model or the second model respectively.

16. The method of claim 1, wherein the physical characteristic of the user is related to a head of the user or at least one pinna of the user.

17. The method of claim 1, wherein the sensor data is produced by an imaging device coupled to a mobile device and the sensor data are images captured by the imaging device while the user moves the mobile device around a head or at least one pinna of the user based on a prompt provided via a display associated with the mobile device.

18. The method of claim 1, wherein the first model or the second model is a head-and-torso model, and the first function or the second function is a head related transfer function associated with the first model or the second model respectively.

19. The method of claim 1, wherein the modified function is a head related transfer function personalized for the user.

20. A system comprising:
a computing device including an imaging sensor, and
an electronic processor coupled to the computing device and configured to:
receive, from the imaging sensor, sensor data corresponding with a physical characteristic of a user;
determine a first function associated based on a similarity between the physical characteristic of the user and a first model;
determine a second function based on a similarity of the physical characteristic between the user and a second model;
generate a modified function, representing an audio response, by combining the first function and the second function; and
generate an audio stream based on the modified function.

21. The system of claim 20, wherein the electronic processor is further configured to provide the audio stream to the computing device.
